(19) United States
(12) Patent Application Publication
(10) Pub. No.: US 2016/0155592 A1
(43) Pub. Date: Jun. 2, 2016

(54) CONTACT DEVICE AND ELECTROMAGNETIC RELAY MOUNTED WITH SAME

(71) Applicant: PANASONIC INTELLECTUAL PROPERTY MANAGEMENT CO., LTD., Osaka (JP)

(72) Inventors: Masahiro ITO, Mie (JP); Tsukasa NISHIMURA, Hokkaido (JP)

(21) Appl. No.: 14/392,130

(22) PCT Filed: Jun. 27, 2014
(86) PCT No.: PCT/JP2014/003431

§ 371 Date: Dec. 23, 2015

(30) Foreign Application Priority Data
Jun. 28, 2013 (JP) 2013-136993

(51) Int. Cl. H01H 50/56; H01H 50/36; H01H 50/60

(52) U.S. Cl. CPC H01H 50/56; H01H 50/60; H01H 50/36; H01H 2235/01

(57) ABSTRACT

A contact device includes: a contact block which includes a fixed terminal including a fixed contact formed thereon, and a movable contactor including a movable contact formed thereon; and a driving block including a driving shaft to which the movable contactor is attached, the driving block configured to drive the movable contactor. The contact block includes: a biasing portion configured to bias the movable contactor toward one side in a driving shaft direction; and a yoke disposed at least on an opposite side of the movable contactor in the driving shaft direction while the movable contact is in contact with the fixed contact. The biasing portion includes a biasing end configured to make biasing force act on the movable contactor by pressing a member other than the yoke.

### TECHNICAL FIELD

The present invention relates to a contact device and an electromagnetic relay mounted with the same.

### BACKGROUND ART

There has been known a contact device which includes: a contact block including fixed terminals provided with fixed contacts, and a movable contactor provided with movable contacts configured to come into and out of contact with the fixed contacts; and a driving block including a driving shaft configured to drive the movable contactor (for example, see Patent Literature 1).

According to Patent Literature 1, the movable contactor is attached to an end portion of the driving shaft formed to reciprocate in its axial direction. In addition, the movable contactor is held between and by an upper yoke and a lower yoke, and is biased by a contact pressure spring toward the fixed contacts. While the movable contacts and the fixed contacts are in contact with each other to allow the flow of electric current, the upper yoke and the lower yoke form a magnetic circuit to produce magnetic force of causing the upper yoke and the lower yoke to attract each other, and thus restrict the movement of the movable contactor away from the fixed contacts.

### CITATION LIST

### Patent Literature

Patent Literature 1: Japanese Patent Laid-open Publication No. 2012-022982

### SUMMARY OF INVENTION

### Technical Problem

According to the above-mentioned conventional technique, the contact pressure spring biases the movable contactor via the lower yoke toward one end of the driving shaft. Since the contact pressure spring is thus configured to bias the movable contactor by pressing the lower yoke provided on the lower side of the movable contactor, the placement position of the contact pressure spring is limited to the lower surface of the lower yoke.

With the above taken into consideration, an object of the present invention is to obtain a contact device, and an electromagnetic relay mounted with the contact device, which both achieve an increase in the freedom of layout of the biasing portion configured to bias the movable contactor.

### Solution to Problem

A gist of a contact device of the present invention is as follows. The contact device includes: a contact block which includes a fixed terminal including a fixed contact formed thereon, and a movable contactor including a movable contact formed thereon to come into and out of contact with the fixed contact; and a driving block including a driving shaft to which the movable contactor is attached, and configured to drive the movable contactor in order that the movable contact come into and out of contact with the fixed contact. The contact block includes: a biasing portion configured to bias the movable contactor toward one side in a driving shaft direction; and a yoke disposed at least on an opposite side of the movable contactor in the driving shaft direction while the movable contact is in contact with the fixed contact. The biasing portion includes a biasing end configured to make biasing force act on the movable contactor by pressing a member other than the yoke.

Another gist of the contact device of the present invention is that the biasing end is located on the one side in the driving shaft direction rather than on a surface of the yoke on the opposite side in the driving shaft direction.

Another gist of the contact device of the present invention is that the biasing end is flush with the surface of the yoke on the opposite side in the driving shaft direction, or located on the one side in the driving shaft direction rather than on a surface of the yoke on the opposite side in the driving shaft direction.

Another gist of the contact device of the present invention is that the biasing portion directly biases the movable contactor.

Another gist of the contact device of the present invention is that the biasing portion biases the movable contactor by pressing a member other than the movable contactor.

Another gist of the contact device of the present invention is that: the yoke includes at least a hole portion formed to penetrate the yoke in the driving shaft direction; and the biasing end is housed inside the hole portion.

Another gist of the contact device of the present invention is that: the yoke includes a first yoke including at least a part disposed on the opposite side of the movable contactor in the driving shaft direction; and the first yoke and the movable contactor are fixed to each other using fixing means.

Another gist of the contact device of the present invention is that the fixing means includes press-fitting means for fixing the first yoke and the movable contactor by press-fitting a press-fitting portion, which is formed on at least one of the first yoke and the movable contactor, to a press-fitted portion which is formed in the other of the first yoke and the movable contactor.

Another gist of the contact device of the present invention is that the press-fitting portion includes a press-fitting projection formed on at least one of the first yoke and the movable contactor.

Another gist of the contact device of the present invention is that the press-fitting projection includes a projection formed by dowel formation processing.

Another gist of the contact device of the present invention is that the press-fitted portion includes at least one of an insertion hole and an insertion recess in which to insert the press-fitting projection.

Another gist of the contact device of the present invention is that the press-fitted portion includes a step.

Another gist of the contact device of the present invention is that the press-fitted portion includes a tapered portion.

Another gist of the contact device of the present invention is that the press-fitting projection includes an upward-bent portion formed on at least one of the first yoke and the movable contactor.

Another gist of the contact device of the present invention is that the fixing means includes swaging means for fixing the first yoke and the movable contactor by swaging a swaging portion, which is formed on at least one of the first yoke and the movable contactor, to a swaged portion which is formed in the other of the first yoke and the movable contactor.

Another gist of the contact device of the present invention is that the swaging portion includes a swaging projection formed on at least one of the first yoke and the movable contactor.

Another gist of the contact device of the present invention is that the swaging projection includes a projection formed by dowel formation processing.

Another gist of the contact device of the present invention is that the swaged portion includes an insertion hole in which to insert the swaging projection.

Another gist of the contact device of the present invention is that the swaged portion includes a step.

Another gist of the contact device of the present invention is that the swaged portion includes a tapered portion.

Another gist of the contact device of the present invention is that the swaging projection is swaged while press-fitted in the insertion hole.

Another gist of the contact device of the present invention is that the swaging projection includes an upward-bent portion formed on at least one of the first yoke and the movable contactor.

Another gist of the contact device of the present invention is that the fixing means includes welding means for fixing the first yoke and the movable contactor by welding.

Another gist of the contact device of the present invention is that the fixing means includes bonding means for fixing the first yoke and the movable contactor with an adhesive.

Another gist of the contact device of the present invention is that the fixing means includes joint means for fixing the first yoke and the movable contactor by inserting a joint member through insertion portions respectively formed in the first yoke and the movable contactor.

The other gist of an electromagnetic relay of the present invention is that the foregoing contact device is mounted on the electromagnetic relay.

### Advantageous Effects of Invention

The present invention makes it possible to obtain the contact device, and the electromagnetic relay mounted with the contact device, which both achieve an increase in the freedom of layout of the biasing portion configured to bias the movable contactor.

### BRIEF DESCRIPTION OF DRAWINGS

FIG. 1 is a perspective view showing an electromagnetic relay of an embodiment of the present invention.

FIG. 2 is an exploded perspective view showing the electromagnetic relay of the embodiment of the present invention.

FIG. 3 is an exploded perspective view showing a part of a contact device of the embodiment of the present invention in a disassembled manner.

FIG. 4 shows the electromagnetic relay of the embodiment of the present invention. FIG. 4(a) is a cross-sectional view. FIG. 4(b) is a side cross-sectional view taken in a direction orthogonal to a direction in which the view of FIG. 4(a) is taken.

FIG. 5 is a perspective view schematically showing how a movable contactor and a yoke are attached to a driving shaft in the embodiment of the present invention.

FIG. 6 is a perspective view showing components shown in FIG. 5 in a disassembled manner.

FIG. 7 is an exploded perspective view schematically showing the movable contactor, a lower yoke and a contact pressure spring of the embodiment of the present invention.

FIG. 8 schematically shows a method of fixing the movable contactor and the lower yoke in the embodiment of the present invention. FIG. 8(a) is a perspective view. FIG. 8(b) is a cross-sectional view.

FIG. 9 schematically shows a first modification of the method of fixing the movable contactor and the lower yoke. FIG. 9(a) is a perspective view. FIG. 9(b) is a cross-sectional view.

FIG. 10 schematically shows a second modification of the method of fixing the movable contactor and the lower yoke. FIG. 10(a) is a perspective view. FIG. 10(b) is a cross-sectional view.

FIG. 11 schematically shows a third modification of the method of fixing the movable contactor and the lower yoke. FIG. 11(a) is a perspective view. FIG. 11(b) is a cross-sectional view.

FIG. 12 is a cross-sectional view schematically showing a fourth modification of the method of fixing the movable contactor and the lower yoke.

FIG. 13 schematically shows a fifth modification of the method of fixing the movable contactor and the lower yoke. FIG. 13(a) is a perspective view. FIG. 13(b) is a cross-sectional view.

FIG. 14 schematically shows a sixth modification of the method of fixing the movable contactor and the lower yoke. FIG. 14(a) is a perspective view. FIG. 14(b) is a cross-sectional view.

FIG. 15 schematically shows a seventh modification of the method of fixing the movable contactor and the lower yoke. FIG. 15(a) is a perspective view. FIG. 15(b) is a cross-sectional view.

FIG. 16 schematically shows an eighth modification of the method of fixing the movable contactor and the lower yoke. FIG. 16(a) is a perspective view. FIG. 16(b) is a cross-sectional view.

FIG. 17 schematically shows a ninth modification of the method of fixing the movable contactor and the lower yoke. FIG. 17(a) is a perspective view. FIG. 17(b) is a cross-sectional view.

FIG. 18 schematically shows a 10th modification of the method of fixing the movable contactor and the lower yoke. FIG. 18(a) is a perspective view. FIG. 18(b) is a cross-sectional view.

FIG. 19 is a cross-sectional view schematically showing an 11th modification of the method of fixing the movable contactor and the lower yoke.

FIG. 20 includes side views schematically showing modifications of an upper yoke and the lower yoke.

FIG. 21 schematically shows an example where the movable contactor is retained by a holder.

FIG. 22 schematically shows a modification of the lower yoke.

FIG. 23 schematically shows an example where the movable contactor is retained by the holder using the lower yoke shown in FIG. 22.

FIG. 24 is a cross-sectional view schematically showing a modification of the movable contactor.

FIG. 25 is a plan cross-sectional view schematically showing another modification of the lower yoke.

FIG. 26 is a cross-sectional view schematically showing a modification of the electromagnetic relay with a power supply being off.

FIG. 27 is a cross-sectional view schematically showing the electromagnetic relay shown in FIG. 26 with the power supply being on.

FIG. 28 is a side cross-sectional view schematically showing a modification of the contact device, and corresponding to FIG. 4(a).

FIG. 29 is a cross-sectional view schematically showing a first modification of a condition in which the movable contactor is pressed by the contact pressure spring.

FIG. 30 is a cross-sectional view schematically showing a second modification of the condition in which the movable contactor is pressed by the contact pressure spring.

FIG. 31 is a cross-sectional view schematically showing a third modification of the condition in which the movable contactor is pressed by the contact pressure spring.

FIG. 32 is a cross-sectional view schematically showing a fourth modification of the condition in which the movable contactor is pressed by the contact pressure spring.

FIG. 33 is a cross-sectional view schematically showing a fifth modification of the condition in which the movable contactor is pressed by the contact pressure spring.

FIG. 34 is a cross-sectional view schematically showing a sixth modification of the condition in which the movable contactor is pressed by the contact pressure spring.

FIG. 35 is a cross-sectional view schematically showing a seventh modification of the condition in which the movable contactor is pressed by the contact pressure spring.

FIG. 36 is a cross-sectional view schematically showing an eighth modification of the condition in which the movable contactor is pressed by the contact pressure spring.

FIG. 37 is a cross-sectional view schematically showing a ninth modification of the condition in which the movable contactor is pressed by the contact pressure spring.

FIG. 38 is a cross-sectional view schematically showing a 10th modification of the condition in which the movable contactor is pressed by the contact pressure spring.

FIG. 39 schematically shows a coil portion of the contact device shown in FIG. 27. FIG. 39(a) is a perspective view. FIG. 39(b) is an exploded perspective view.

### DESCRIPTION OF EMBODIMENTS

Referring to the drawings, an embodiment of the present invention will be hereinbelow described in detail.

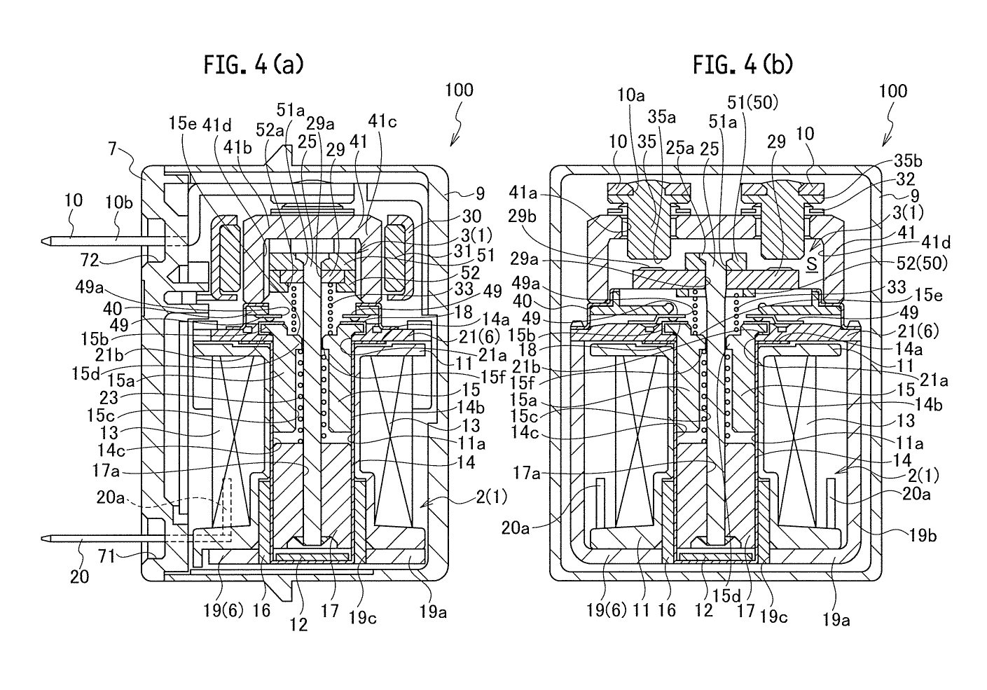

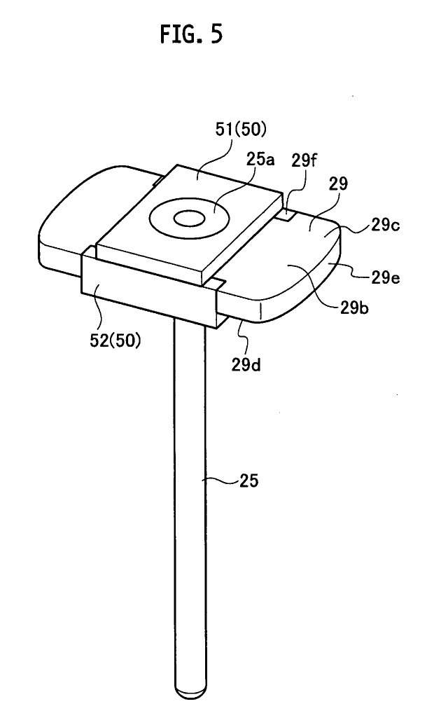

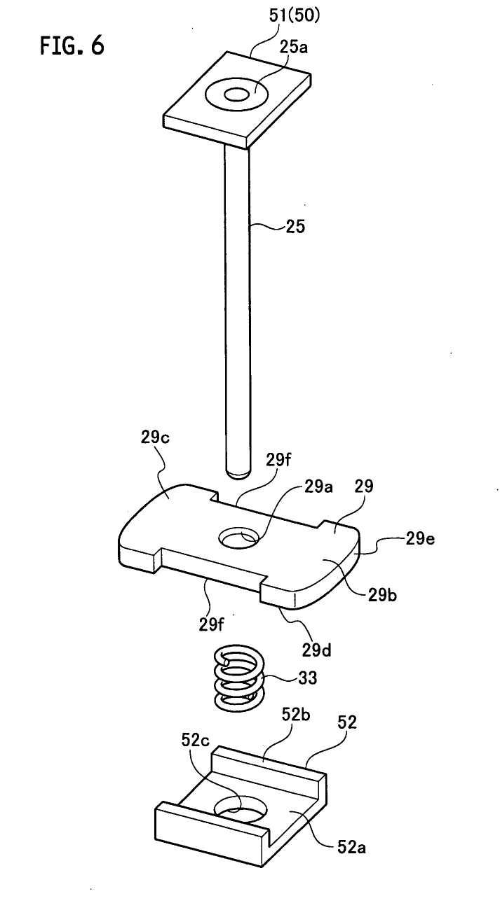

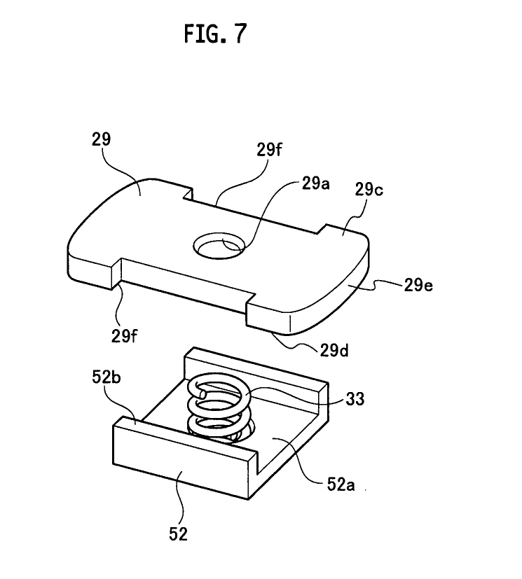

Incidentally, the following descriptions will be provided with the top, bottom, left and right in FIG. 4(b) coinciding with the top, bottom, left and right of an electromagnetic relay, and with the left and right in FIG. 4(a) coinciding with the front and back of the electromagnetic relay.

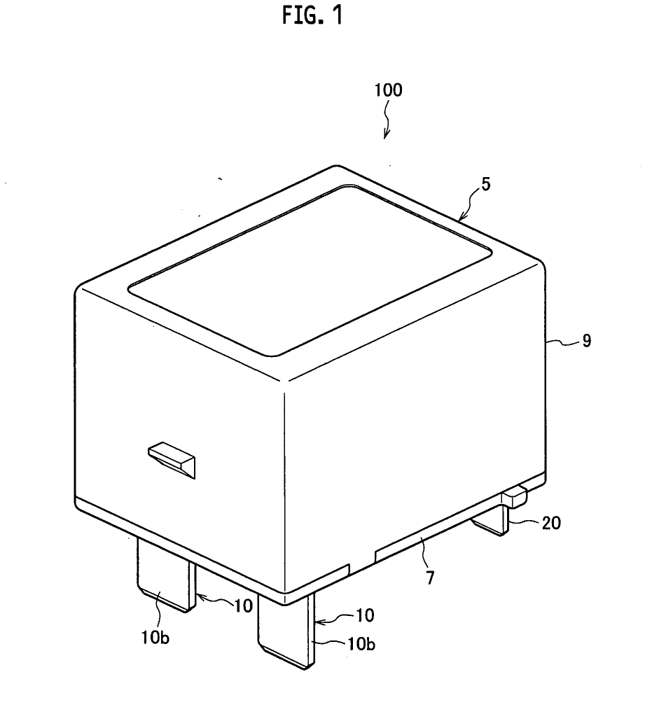

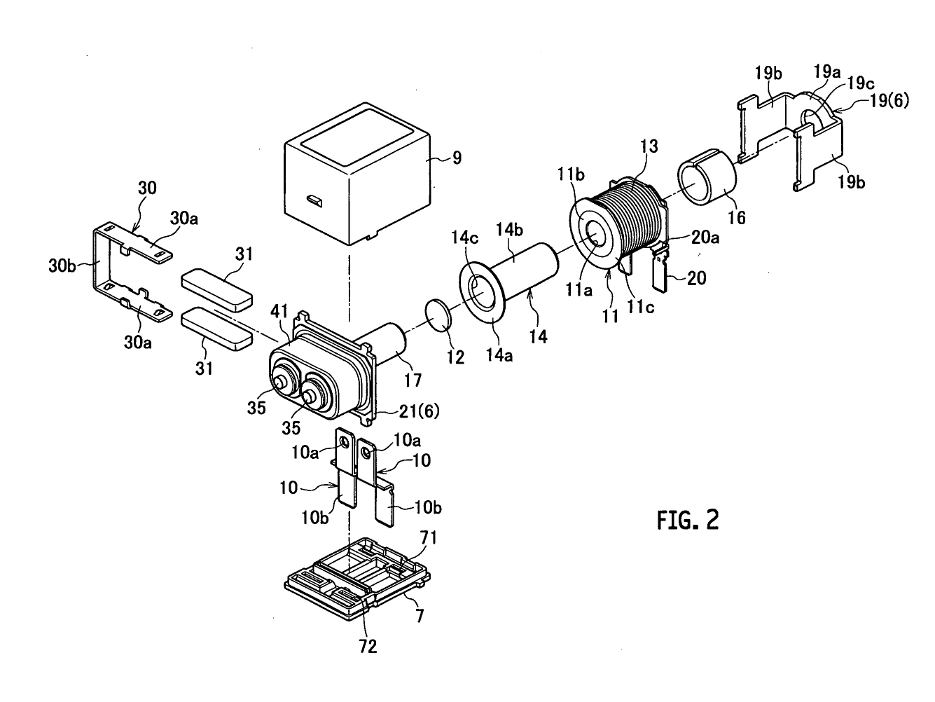

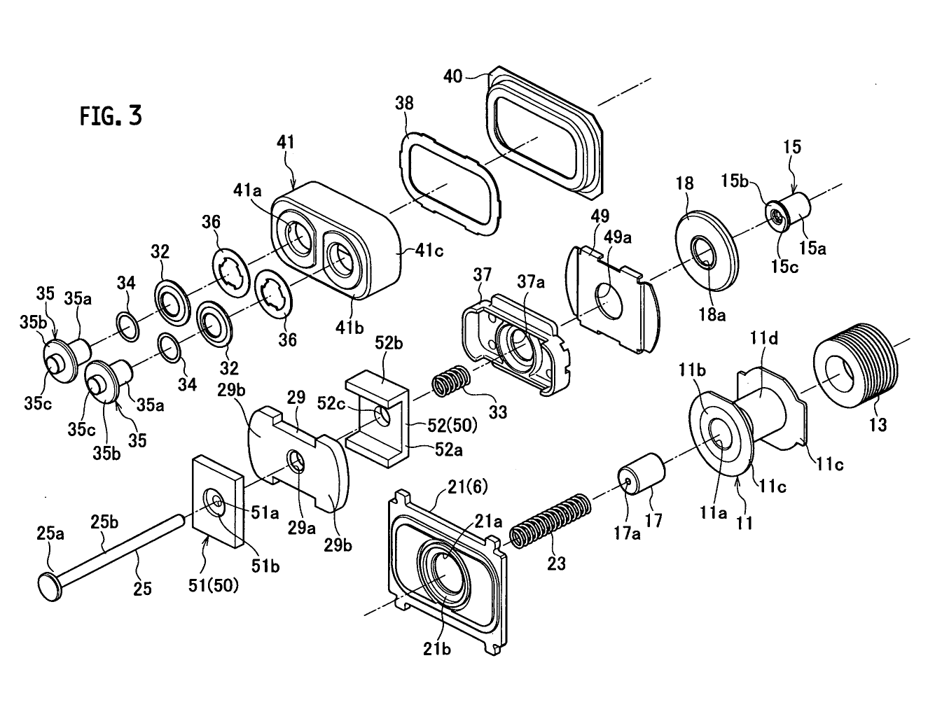

An electromagnetic relay 100 of the embodiment is a so-called normally-open electromagnetic relay whose contacts are off while in the initial state. As shown in FIGS. 1 to 3, the electromagnetic relay 100 includes a contact device 1 constructed by integrally combining a driving block 2 to be located in a lower portion of the contact device 1 and a contact block 3 to be located in an upper portion of the contact device 1. In addition, the contact device 1 is housed inside a case shaped like a hollow box. Incidentally, a so-called normally-closed electromagnetic relay whose contacts are on while in the initial state may be used instead as the electromagnetic relay 100 of the embodiment.

The case 5 includes: a case base portion 7 shaped almost like a rectangle; and a case cover 9 disposed to cover the case base portion 7, and to house mounted parts such as the driving block 2 and the contact block 3.

The case base portion 7 on a lower portion side in FIG. 4 is provided with a pair of slits 71, 71 through which a pair of coil terminals 20 are installed. In addition, the case base portion 7 on an upper portion side in FIG. 4 is provided with a pair of slits 72, 72 through which terminal portions 10b, 10b of a pair of main terminals 10, 10 are installed. On the other hand, the case cover 9 is shaped like a hollow box, which is opened on a side of the case base portion 7. Incidentally, the insertion holes 71 have almost the same shape as the cross section of the coil terminals 20, and the insertion holes 72 have almost the same shape as the cross section of the terminal portions 10b, 10b of the main terminals 10, 10.

The driving block 2 includes: a coil bobbin 11 shaped like a hollow cylinder with a coil 13 wound around the coil bobbin 11; and the pair of coil terminals 20 fixed to the coil bobbin 11 with two ends of the coil 13 connected to the coil terminals 20.

Two upper and lower ends of a cylindrical portion of the coil bobbin 11 are respectively provided with flange portions 11c shaped almost like a circle, and projecting in a circumferential direction. A winding cylindrical portion 11d around which to wind the coil 13 is formed between the upper and lower flange portions 11c.

The coil terminals 20 are made from electrically-conductive material such as copper, and shaped like a flat plate. The pair of coil terminals 20 are respectively provided with relay terminals 20a. Furthermore, lead lines of the two ends of the coil 13 wound around the coil bobbin 11 are welded to the relay terminals 20a with the lead lines wound around the relay terminals 20a.

In addition, the driving block 2 is designed to be driven when the coil 13 is electrified through the pair of coil terminals 20. When the driving block 2 is driven in this manner, contacts formed from fixed contacts 35a and movable contacts 29b of the contact block 3, which will be described later, are opened and closed. Thereby, a pair of fixed terminals 35 are switchable between electrical communication and electrical non-communication.

Furthermore, the driving block 2 includes a yoke 6 made from magnetic material, and surrounding the coil bobbin 11. In the embodiment, the yoke 6 is formed from: a rectangular yoke upper plate 21 in contact with an upper end surface of the coil bobbin 11; and a rectangular yoke 19 in contact with a lower end surface and a side surface of the coil bobbin 11. The yoke 6 is opened in the front-back direction.

The yoke 19 is disposed between the coil 13 and the case 5. The yoke 19 includes a bottom wall 19a, and a pair of side walls 19b, 19b rising from peripheral edges of the bottom wall 19a. In the embodiment, the bottom wall 19a and the pair of side walls 19b, 19b are continuously integrally formed by bending a plate. Moreover, an annular insertion hole 19c is formed in the bottom wall 19a of the yoke 19. A bush 16 made from magnetic material is installed through the insertion hole 19c. Besides, the yoke upper plate 21 is disposed on tip end sides (upper end sides) of the pair of side walls 19b, 19b of the yoke 19 in away that the coil 13 wound around the coil bobbin 11 is covered with the yoke upper plate 21.

The driving block 2 further includes: a fixed iron core 15 fixed to a cylindrical inner portion of the coil bobbin 11 and magnetized by the coil 13 when the coil 13 is electrified; and a movable iron core 17 facing the fixed iron core 15 in a vertical direction (an axial direction) and disposed inside the cylinder of the coil bobbin 11. The fixed iron core 15 is shaped almost like a column. The fixed iron core 15 includes a projection 15a formed including an insertion hole 15c. An upper end of the projection 15a is provided with a flange portion 15b projecting in the circumferential direction.

In the embodiment, the driving block 2 further has a plunger cap 14 between the fixed iron core 15 and the coil bobbin 11 as well as between the movable iron core 17 and the coil bobbin 11. The plunger cap 14 is made from magnetic material, and shaped like an end-closed cylinder whose upper surface is opened. In this embodiment, the plunger cap 14 is disposed inside an insertion hole 11a formed in the center of the coil bobbin 11. When the plunger cap 14 is thus disposed, a flange portion 14a of the plunger cap 14 is placed on an annular seat surface 11b which is formed in an upper side of the coil bobbin 11. In addition, a protrusion 14b of the plunger cap 14 is fitted in the insertion hole 11a. Furthermore, the fixed iron core 15 and the movable iron core 17 are to be housed in the plunger cap 14 provided inside the cylinder of the coil bobbin 11. Incidentally, the fixed iron core 15 is disposed on an opening side of the plunger cap 14.

Moreover, the fixed iron core 15 and the movable iron core 17 are each shaped like a column such that their outer diameters are almost equal to an inner diameter of the plunger cap 14. The movable iron core 17 is designed to slide over the inner portion of the cylinder of the plunger cap 14. A range of movement of the movable iron core 17 is set between an initial position away from the fixed iron core 15 and a contact position where the movable iron core 17 is in contact with the fixed iron core 15. Besides, the return spring 23 is interposed between the fixed iron core 15 and the movable iron core 17. The return spring 23 is formed from a coil spring and configured to bias the movable iron core 17 in a direction in which the movable iron core 17 is returned to the initial position. The return spring 23 biases the movable iron core 17 in a direction in which the movable iron core 17 goes farther from the fixed iron core 15 (upward in FIG. 4). Incidentally, in the embodiment, a projection 15d is provided in the inside of the insertion hole 15c of the fixed iron core 15 such that the projection 15d extends along the full circumference of the insertion hole 15c, and projects toward the center of the insertion hole 15c to make the diameter of the hole smaller. A lower surface 15f of the projection 15d serves as a spring receiving portion for the return spring 23.

In addition, an insertion hole 21a through which to insert the fixed iron core 15 is penetratingly provided in a central portion of the yoke upper plate 21. The insertion of the fixed iron core 15 through the insertion hole 21a is achieved by inserting the cylindrical portion 15b of the fixed iron core 15 into the insertion hole 21a from the upper surface side of the yoke upper plate 21. The thus-inserted fixed iron core 15 is retained by fitting the flange portion 15b of the fixed iron core 15 to a recess 21b which is provided almost at the center of the upper surface of the yoke upper plate 21, and whose diameter is almost equal to that of the flange portion 15b of the fixed iron core 15.

Besides, a metal-made holding plate 49 is provided on a side of the upper surface of the yoke upper plate 21. The right and left end portions of the holding plate 49 are fixed to the upper surface of the yoke upper plate 21. The center of the holding plate 49 is provided with a projection so as to form a space for housing the flange portion 15b of the fixed iron core 15 which juts out from the upper surface of the yoke upper plate 21. Furthermore, in the embodiment, an iron core rubber 18 made from a material (for example, synthetic rubber) having rubber elasticity is provided between the fixed iron core 15 and the holding plate 49; and the core rubber 18 prevents direct propagation of vibrations from the fixed iron core 15 to the holding plate 49. The core rubber 18 is shaped like a disk, and an insertion hole 18a through which to insert a shaft (driving shaft) 25, which will be described later, is penetratingly provided in a central portion of the core rubber 18. Moreover, in the embodiment, the core rubber 18 is fittingly attached to the fixed iron core 15 so as to wrap the flange portion 15b.

The flange portion 14a projecting in the circumferential direction is formed on the opening side of the plunger cap 14, and is fixedly attached to the periphery of the insertion hole 21a in the lower surface of the yoke upper plate 21. A lower end bottom portion of the plunger cap 14 is inserted through the bush 16 installed in the insertion hole 19c of the bottom wall 19a. When the lower end bottom portion of the plunger cap 14 is inserted through the bush 16, the movable iron core 17 housed in the lower portion of the plunger cap 14 is magnetically joined to the peripheral portion of the bush 16.

When the coil 13 is electrified, this configuration makes a pair of magnetic pole portions, which are formed from a surface of the fixed iron core 15 facing the movable iron core 17 and a peripheral portion of the bottom wall 19a surrounding the bush 16, have mutually opposite polarities. Accordingly, the movable iron core 17 moves to the contact position by being attracted by the fixed iron core 15. On the other hand, once the electrification of the coil 13 is stopped, the return spring 23 returns the movable iron core 17 to the initial position. Incidentally, the return spring 23 is inserted through the insertion hole 15c of the fixed iron core 15 with the upper end of the return spring 23 in contact with the lower surface 15f of the projection 15d, and with the lower surface of the return spring 23 in contact with the upper surface of the movable iron core 17. Besides, in the embodiment, a bottom portion of the inside of the plunger cap 14 is provided with a dumper rubber 12 which is made from material having rubber elasticity, and whose diameter is almost equal to the outer diameter of the movable iron core 17.

The contact block 3 is provided above the driving block 2 to open and close the contacts depending on whether or not the coil 13 is electrified.

The contact block 3 is provided with a base 41 which is made from heat resistant material, and which is shaped like a box whose lower surface is opened. The bottom portion of the base 41 is provided with two insertion holes 41a. The pair of fixed terminals 35 are inserted through the insertion holes 41a with lower flanges 32 interposed in between, respectively. The fixed terminals 35 are each made from electrically-conductive material such as copper-based material, and shaped like a cylinder. The fixed contacts 35a are formed on the lower end surfaces of the fixed terminals 35. Flange portions 35b projecting in the circumferential direction are formed on the upper end portion of the fixed terminals 35. The centers of the flange portions 35b are provided with projections 35c. The upper surfaces of the lower flanges 32 and the flange portions 35b of the fixed terminals 35 are hermetically joined to each other using silver solders 34. The lower surfaces of the lower flanges 32 and the upper surface of the base 41 are hermetically joined to each other using silver solders 36 as well.

In addition, the pair of main terminals 10, 10 connected to external load or the like are attached to the fixed terminals 35. The main terminals 10, 10 are made from electrically-conductive material, and shaped like a flat plate. Intermediate portions of the main terminals 10, 10 in the front-back direction are bent in a stepped manner. Insertion holes 10a, 10a through which to insert the projections 35c of the fixed terminals 35 are formed in the front ends of the main terminals 10, 10. The main terminals 10, 10 are fixed to the fixed terminals 35 by spin-swaging the projections 35c inserted through the insertion holes 10a, 10a.

Furthermore, a movable contactor 29 is disposed inside the base 41 such that the movable contactor 29 extends from one to the other of the pair of fixed contacts 35a. Portions of the upper surface of the movable contactor 29 which face the fixed contacts 35a are provided with the movable contacts 29b, respectively. An insertion hole 29a through which to insert one end portion of the shaft 25 connecting the movable contactor 29 to the movable iron core 17 is penetratingly provided in a central portion of the movable contactor 29.

The shaft 25 is made from non-magnetic material, and includes: a bar-shaped shaft main body 25b elongated in the direction of the movement of the movable iron core 17 (the vertical direction); and a flange portion 25a formed on a portion of the shaft main body 25b which juts upward from the movable contactor 29 such that the flange portion 25a projects in the circumferential direction.

Moreover, an electrically-insulating plate 37 and a contact pressure spring (biasing portion) 33 are provided between the movable contactor 29 and the holding plate 49. The electrically-insulating plate 37 is made from electrically-insulating material, and formed covering the holding plate 49. The contact pressure spring 33 is formed from a coil spring, and the shaft 25 is inserted through the contact pressure spring 33. Incidentally, the center of the electrically-insulating plate 37 is provided with an insertion hole 37a through which to insert the shaft 25. The contact pressure spring 33 biases the movable contactor 29 in the upward direction (toward one side in the driving shaft direction).

In this respect, a positional relationship between the movable iron core 17 and the movable contactor 29 is set such that when the movable iron core 17 is in the initial position, the movable contacts 29b are away from the fixed contacts 35a, and such that when the movable iron core 17 is in the contact position, the movable contacts 29b are in contact with the fixed contacts 35a. In other words, while the coil 13 is not electrified, the contact device 3 is off, and the two fixed terminals 35 are electrically insulated from each other. While the coil 13 is being electrified, the contact block 3 is on, and the two fixed terminals 35 are electrically conductive to each other. Incidentally, the contact pressure spring 33 secures the contact pressure between the movable contacts 29b and the fixed contacts 35a.

Meanwhile, while the movable contacts 29b of the movable contactor 29 are in contact with the fixed contacts 35a, 35a to allow the flow of electric current, this electric current makes electromagnetic repulsive force act between the fixed contacts 35a, 35a and the movable contactor 29. The action of the electromagnetic repulsive force between the fixed contacts 35a, 35a and the movable contactor 29 decreases the contact pressure therebetween to increase the contact resistance therebetween and accordingly the Joule heat sharply, or makes the contacts therebetween become open to cause arc heat therebetween. These make it more likely that the movable contacts 29b and the fixed contacts 35a are welded to each other.

With this taken into consideration, the present embodiment is provided with a yoke 50 which, while the movable contacts 29b are in contact with the fixed contacts 35a (in the embodiment, while the power supply is on), is disposed at least on the lower side of the movable contactor 29 (on the opposite side in the driving shaft direction) (i.e., disposed in contact with a lower surface 29d of the movable contactor 29).

To put it concretely, the yoke 50 surrounding upper, lower and side surfaces 29c, 29d, 29e of the movable contactor 29 is formed from: an upper yoke (second yoke) 51 disposed on the upper side of the movable contactor 29; and a lower yoke (first yoke) 52 surrounding lower and side portions of the movable contactor 29. In other words, the yoke 50 is disposed at least on the lower side of the movable contactor 29 (on the opposite side in the driving shaft direction) (i.e., disposed in contact with the lower surface 29d), too, while the movable contacts 29b are away from the fixed contacts 35a (in the embodiment, while the power supply is off).

A magnetic circuit is formed between the upper yoke 51 and the lower yoke 52 by making the upper yoke 51 and the lower yoke 52 surround the movable contactor 29 in this manner.

Furthermore, provision of the upper yoke 51 and the lower yoke 52 realizes that, while the movable contacts 29b and the fixed contacts 35a, 35a are in contact with each other to allow the flow of the electric current, the upper yoke 51 and the lower yoke 52 produce mutually-attracting magnetic force on the basis of the electric current. The production of the mutually-attracting magnetic force like this makes the upper yoke 51 and the lower yoke 52 attract each other. The attraction between the upper yoke 51 and the lower yoke 52 makes the fixed contacts 35a press the movable contactor 29, and accordingly restricts the movement of the movable contactor 29 to separate from the fixed contacts 35a. Since the movement of the movable contactor 29 to separate from the fixed contacts 35a is restricted in this manner, the movable contacts 29b are attracted to the fixed contacts 35a without the movable contactor 29 repelling the fixed contacts 35a. Accordingly, the occurrence of the arc is inhibited. As a result, it is possible to inhibit the contacts from being welded to each other due to the occurrence of the arc.

Moreover, in the embodiment, the upper yoke 51 is shaped almost like a rectangular plate; and the lower yoke 52 includes a bottom wall portion 52a, and side wall portions 52b formed to rise from two ends of the bottom wall portion 52a, such that the bottom wall portion 52a and the side wall portions 52b make the lower yoke 52 shaped almost like the letter U. In this respect, it is desirable that, as shown in FIG. 4(a), the upper end surfaces of the side wall portions 52b of the lower yoke 52 be in contact with the lower surface of the upper yoke 51. However, the upper end surfaces of the side wall portions 52b of the lower yoke 52 do not have to be in contact with the lower surface of the upper yoke 51.

In addition, in the embodiment, the contact pressure spring 33 biases the movable contactor 29 in the upper direction. To put it concretely, the upper end of the contact pressure spring 33 is in contact with the lower surface 29d of the movable contactor 29, while the lower end of the contact pressure spring 33 is in contact with an upper surface 15e of the projection 15d. In this manner, in the embodiment, the upper surface 15e of the projection 15d serves as a spring receiving portion for the contact pressure spring 33.

Furthermore, the insertion holes 51a, 52c and 49a in which to insert the shaft 25 are respectively formed in the upper yoke 51, the lower yoke 52 and the holding plate 49.

Moreover, as described below, the movable contactor 29 is attachable to the one end portion of the shaft 25.

To begin with, the movable iron core 17, the return spring 23, the yoke upper plate 21, the fixed iron core 15, the core rubber 18, the holding plate 49, the electrically-insulating plate 37, the contact pressure spring 33, the lower yoke 52, the movable contactor 29 and the upper yoke 51 are disposed in this order from the bottom. When these components are thus disposed, the return spring 23 is inserted through: the insertion hole 21a of the yoke upper plate 21; and the insertion hole 15c of the fixed iron core 15 whose projection 15a is fitted in an insertion hole 14c of the plunger cap 14.

Thereafter, from the upper side of the upper yoke 51, the main body 25b of the shaft 25 is inserted through the insertion holes 51a, 29a, 52c, 37a, 49a, 18a, 15c, 21a, the contact pressure spring 33, the return spring 23 and an insertion hole 17a of the movable iron core 17. Subsequently, the shaft 25 is connected to the movable iron core 17. In the embodiment, the fastening of the shaft 25 to the movable iron core 17 is performed by squeezing the tip end of the shaft 25 which is used as a rivet, as shown in FIG. 4. Incidentally, the shaft 25 may be instead fastened to the movable iron core 17 by: forming a thread groove in the other end portion of the shaft 25; and screwing the shaft 25 to the movable iron core 17.

In this manner, the movable contactor 29 is attached to the one end portion of the shaft 25. In the embodiment, an annular seat surface 51b is formed on the upper side of the upper yoke 51. The shaft 25 is retained with its upper projection inhibited by housing the flange portion 25a of the shaft 25 in the seat surface 51b. Incidentally, the shaft 25 may be instead fixed to the upper yoke 51 by laser welding or the like.

Furthermore, the inner diameter of the insertion hole 15c provided in the fixed iron core 15 is set larger than the outer diameter of the shaft 25 such that the shaft 25 at least does not contact the fixed iron core 15. This configuration makes the movable contactor 29 move in the vertical direction in response to the movement of the movable iron core 17.

Moreover, in the embodiment, the base 41 is filled with a gas in order to inhibit the arc from occurring between the movable contacts 29b and the fixed contacts 35a when the movable contacts 29b are brought away from the fixed contacts 35a. As such a gas, a mixed gas mainly containing a hydrogen gas may be used because the hydrogen gas is the best in thermal conductivity in a temperature range where the arc is most likely to occur. In the embodiment, an upper flange 40 configured to cover a gap between the base 41 and the yoke upper plate 21 is provided in order to seal the gas in the base 41.

To put it concretely, the base 41 includes: a top wall 41b provided with the pair of insertion holes 41a arranged side-by-side; and a prism-shaped wall portion 41c rising from the peripheral edge of the top wall 41b. The base 41 is formed like a hollow box whose lower side (on the side of the movable contactor 29) is opened. With the movable contactor 29 housed inside the wall portion 41c from the opened lower side, the base 41 is fixed to the yoke upper plate 21 with the upper flange 40 interposed in between.

In the embodiment, the peripheral edge portion of the opening in the lower surface of the base 41 is hermetically joined to the upper surface of the upper flange 40 with silver solder 38, while the lower surface of the upper flange 40 is hermetically joined to the upper surface of the yoke upper plate 21 by arc welding or the like. In addition, the lower surface of the yoke upper plate 21 is hermetically joined to the flange portion 14a of the plunger cap 14 by arc welding or the like. Thereby, a sealed space S filled with the gas is formed inside the base 41.

Furthermore, the embodiment inhibits the arc using a capsule yoke while performing the arc inhibiting method using the gas. The capsule yoke is formed from a magnetic member 30 and a pair of permanent magnets 31. The magnetic member 30 is made from a magnetic material such as iron, and shaped almost like the letter U. The magnetic member 30 is integrally formed from a pair of mutually-facing side pieces 30a, and a connecting piece 30b connecting base end portions of the respective side pieces 30a.

The permanent magnets 31 are attached to the two side pieces 30a of the magnetic member 30 so as to face both side pieces 30a. The permanent magnets 31 give the base 41 a magnetic field extending almost orthogonal to the direction in which the movable contacts 29a come into and out of contact with the fixed contacts 35a. Thereby, the arc is elongated in a direction orthogonal to the direction of the movement of the movable contactor 29, and is concurrently cooled by the gas filled in the base 41. When the arc voltage sharply rises to exceed the voltage between the contacts, the arc is interrupted. In other words, in the electromagnetic relay 100 of the embodiment, the measure to counter the arc is achieved by: making the capsule yoke magnetically blow out the arc; and cooling the arc with the gas filled in the base 41. Thereby, the arc can be interrupted in a short length of time, while the fixed contacts 35a and the movable contact's 29b can be less consumed.

Meanwhile, in the electromagnetic relay 100 of the embodiment, since the plunger cap 14 guides the movable iron core 17 in its movement direction (in the vertical direction), restrictions are imposed on the position of the movable iron core 17 in a plane orthogonal to the movement direction of the movable iron core 17. For this reason, restrictions are also imposed on the position of the shaft 25 connected to the movable iron core 17 in the plane orthogonal to the movement direction of the movable iron core 17. Furthermore, in the embodiment, since the shaft 25 is inserted through the insertion hole 15c of the fixed iron core 15, restrictions are imposed on the position of the shaft 25 in the plane orthogonal to the movement direction of the movable iron core 17. In other words, the insertion hole 15c of the fixed iron core 15 is formed such that the inner diameter of a portion of the insertion hole 15c on which the projection 15d is formed is almost equal to the outer diameter of the shaft 25. That is to say, the inner diameter of the insertion hole 15c is set large enough to allow the shaft 25 to move in the vertical direction while restricting the forward, backward, leftward and rightward movement of the shaft 25.

Due to such configuration, the shaft 25 is to be restricted at two components, that is to say, the plunger cap 14 and the projection 15d of the fixed iron core 15, from tilting toward the movement direction of the movable iron core 17. For this reason, even when the shaft 25 becomes more likely to tilt toward the movement direction of the movable iron core 17, the position of the shaft 25 in the plane orthogonal to the movement direction of the movable iron core 17 is restricted by the two components, that is to say, the lower end of the movable iron core 17 and the projection 15d of the fixed iron core 15. Thereby, the tilt of the shaft 25 is restricted. As a result, the shaft 25's ability to move straight can be secured, and the tilt of the shaft 25 can be inhibited.

Next, descriptions will be provided for how the contact device 1 works.

First of all, while the coil 13 is not electrified, the elastic force of the return spring 23 is greater than the elastic force of the contact pressure spring 33. For this reason, the movable iron core 17 moves in the direction of going away from the fixed iron core 15. Accordingly, the movable contacts 29b are put in a state shown in FIGS. 4(a) and 4(b) where the movable contacts 29b are away from the fixed contacts 35a.

Once the coil 13 is electrified in this off state, electromagnetic force is generated, and the movable iron core 17 thereby moves closer to the fixed iron core 15 by being attracted by the fixed iron core 15 against the elastic force of the return spring 23. In response to the upward movement of the movable iron core 17 (toward the fixed iron core 15), the shaft 25, as well as the upper yoke 51, the movable contactor 29 and the lower yoke 52 attached to the shaft 25, moves upward (toward the fixed contacts 35a). Thereby, the movable contacts 29b of the movable contactor 29 come into contact with the fixed contacts 35a of the fixed terminals 35. Accordingly, electrical communication is established between the contacts, and the contact device 1 is turned on.

In this respect, the embodiment makes it possible to achieve a further increase in freedom of layout of the contact pressure spring (biasing portion) 38 configured to bias the movable contactor 29.

To put it concretely, the contact pressure spring (biasing portion) 33 includes a biasing end configured to make upward biasing force (toward the one side in the driving shaft direction) act on the movable contactor 29 by pressing a member other than the yoke 50.

In other words, the biasing end of the contact pressure spring (biasing portion) 33 is configured to make the upward biasing force act on the movable contactor 29 by pressing a member other than the yoke 50, instead of by directly pressing the yoke 50.

In the embodiment, an upper end 33a of the contact pressure spring (biasing portion) 33 corresponds to the biasing end. Furthermore, the contact pressure spring (biasing portion) 33 is configured to directly bias the movable contactor 29 by making the upper end (biasing end) 33a directly press the lower surface 29d of the movable contactor 29 (a member other than the yoke 50).

It should be noted that the upper end (biasing end) 33a of the contact pressure spring (biasing portion) 33 may be configured to indirectly press the yoke 50 upward as long as the upper end (biasing end) 33a thereof does not directly press the yoke 50 upward (toward the one side in the driving shaft direction, or toward the movable contactor 29). In other words, the upper end (biasing end) 33a of the contact pressure spring (biasing portion) 33 may be configured to press the member other than the yoke 50 such that the member other than the yoke 50 resultantly presses the axially opposite surface of the yoke 50 toward the one side in the driving shaft direction.

Moreover, in the embodiment, the contact device 1 can be reduced in size in its height direction (the vertical direction, or the driving shaft direction).

To put it concretely, the upper end (biasing end) 33a of the contact pressure spring (biasing portion) 33 is located higher than a lower surface (a surface of the yoke 50 on the opposite side in the driving shaft direction) 52d of the lower yoke (first yoke) 52 (i.e., located on the one side in the driving shaft direction, or closer to the movable contactor 29).

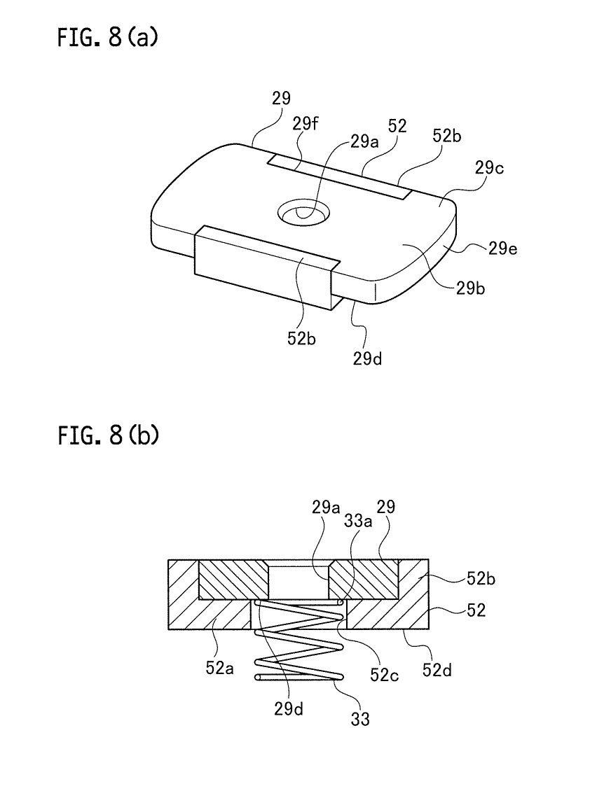

In the embodiment, as shown in FIG. 8(b), the diameter of the insertion hole 52c of the lower yoke 52 is made larger than the diameter of the insertion hole 29a of the movable contactor 29 and the diameter of the shaft 25, while the insertion hole 52c and the insertion hole 29a are disposed coaxial with each other. Furthermore, the upper portion of the contact pressure spring (biasing portion) 33 is inserted through a gap between the insertion hole 52c and the shaft 25, and the upper end (biasing end) 33a is put in contact with the lower surface 29d of the movable contactor 29 (a portion of the lower surface 29d which does not coincide with the lower yoke 52 when viewed from under).

In the embodiment, in this manner, the lower yoke 52 includes at least the insertion hole (hole portion) 52c formed to penetrate the lower yoke 52 in the driving shaft direction, and the upper end (biasing end) 33a of the contact pressure spring (biasing portion) 33 is housed in the insertion hole (hole portion) 52c.

Thereby, the upper end (biasing end) 33a of the contact pressure spring (biasing portion) 33 makes the upward biasing force act on the movable contactor 29 without being in contact with the lower yoke 52 (the yoke 50) (i.e., without the yoke interposed between the upper end (biasing end) 33a and the movable contactor 29). In other words, in the embodiment, the contact pressure spring (biasing portion) 33 biases the movable contactor 29 upward directly without the lower yoke 52 (the yoke 50) interposed in between.

It should be noted that it suffices if the upper end (biasing end) 33a is not in contact with the lower yoke 52 (the yoke 50) in the vertical direction (the driving shaft direction). In other words, the expression stating “without being in contact with the lower yoke 52 (the yoke 50)” does not mean that the expression excludes, for example, a configuration in which the positional displacement of the contact pressure spring (biasing portion) 33 in the lateral direction brings the upper end (biasing end) 33a into contact with the side surface of the lower yoke 52 (the yoke 50) (i.e., the inner peripheral surface of the insertion hole 52c).

Moreover, in the embodiment, the lower yoke (first yoke) 52 and the movable contactor 29 are fixed to each other using press-fitting means as fixing means.

To put it concretely, the lower yoke (first yoke) 52 and the movable contactor 29 are fixed to each other by press-fitting the side wall portions (press-fitting portions) 52b formed in the lower yoke 52, which is at least one of the lower yoke 52 and the movable contactor 29, to cutouts (press-fitted portions) 29f formed in the movable contactor 29 which is the other of the lower yoke 52 and the movable contactor 29.

In the embodiment, the side wall portions 52b as the press-fitting portions correspond to press-fitting projections. The configuration of the embodiment is made such that the press-fitting portions include the press-fitting projections formed on at least one of the lower yoke (first yoke) 52 and the movable contactor 29.

Besides, in the embodiment, the lower yoke (first yoke) 52 is formed to include the bottom wall portion 52a, and the side wall portions 52b rising from the two ends of the bottom wall portion 52a, which are formed by bending the two ends of the plate-shaped member upward in the same direction.

In other words, the side wall portions 52b of the embodiment correspond to upward-bent portions. For this reason, the configuration of the embodiment is also made such that the press-fitting projections include the upward-bent portions formed on at least one of the lower yoke (first yoke) 52 and the movable contactor 29.

It should be noted that insertion holes or insertion recesses in which to insert the side wall portions 52b by press-fitting may be formed in the movable contactor 29. Otherwise, press-fitting projections such as upward-bent portions may be formed on the movable contactor 29. Instead, press-fitting projections such as upward-bent portions may be formed on both the lower yoke (first yoke) 52 and the movable contactor 29, and press-fitted portions such as cutouts, insertion holes or insertion recesses may be formed in positions on both the lower yoke (first yoke) 52 and the movable contactor 29 which correspond to the press-fitting projections.

As explained above, in the embodiment, the contact pressure spring (biasing portion) 33 includes the upper end (biasing end) 33a configured to make the upward biasing force act on the movable contactor 29 by directly pressing the movable contactor 29 which is a member other than the yoke 50.

Because of the configuration in which, as described above, the upper end (biasing end) 33a of the contact pressure spring (biasing portion) 33 presses the member (in the embodiment, the movable contactor 29) other than the yoke 50, it is possible to achieve a further increase in freedom of layout of the contact pressure spring (biasing portion) 33 configured to bias the movable contactor 29.

Furthermore, in the embodiment, the contact pressure spring (biasing portion) 33 includes the upper end (biasing end) 33a located higher than the lower surface (the surface of the yoke 50 on the opposite side in the driving shaft direction) 52d of the lower yoke (first yoke) 52 (i.e., located on the one side in the driving shaft direction), and configured to make the upward biasing force act on the movable contactor 29 without being in contact with the lower yoke 52 (the yoke 50) (i.e., without the yoke interposed in between). In other words, the upper end (biasing end) 33a of the contact pressure spring (biasing portion) 33 is located higher than the lower surface (the surface of the yoke 50 on the opposite side in the driving shaft direction) 52d of the lower yoke (first yoke) 52 (i.e., located on the one side in the driving shaft direction, or closer to the movable contactor 29).

As a result, the contact device 1 can be reduced in size in its height direction (the vertical direction, or the driving shaft direction).

Moreover, in the embodiment, the contact pressure spring (biasing portion) 33 biases the movable contactor 29 upward directly without the lower yoke 52 (the yoke 50) interposed in between. For this reason, the height of the contact device 1 can be made smaller by the thickness of the lower yoke (first yoke) 52 than in a case where the upper end (biasing end) 33a of the contact pressure spring (biasing portion) 33 is in contact with the lower yoke (first yoke) 52.

Simultaneously, the movable contactor 29 can be reduced in weight since the movable contactor 29 is shaped like a plate, and since the upper and lower surfaces 29c, 29d of the plate-shaped movable contactor 29 are each formed as a flat surface. The lighter weight of the movable contactor 29 like this makes it possible to increase the contact opening speed. The increased contact opening speed makes it possible to quicken the interruption, and accordingly to extend the life of the contact device 1.

Besides, in the embodiment, the upper end (biasing end) 33a of the contact pressure spring (biasing portion) 33 is inserted through the insertion hole (hole portion) 52c formed in the lower yoke 52, and at least penetrating the lower yoke 52 in the driving shaft direction. For this reason, the positional displacement of the contact pressure spring (biasing portion) 33 can be inhibited by the insertion hole 52c and can make the upper biasing force more stably act on the movable contactor 29.

In addition, in the embodiment, the lower yoke (first yoke) 52 and the movable contactor 29 are fixed to each other using the fixing means. As a result, the positional displacement of the lower yoke (first yoke) 52 relative to the movable contactor 29 is inhibited. For this reason, it is possible to more securely restrict the movable contactor 29 from going away from the fixed contacts 35a.

Furthermore, in the embodiment, the lower yoke (first yoke) 52 and the movable contactor 29 are fixed to each other using the press-fitting means as the fixing means. For this reason, the lower yoke (first yoke) 52 can be fixed to the movable contactor 29 while being aligned to the movable contactor 29.

Moreover, since the lower yoke (first yoke) 52 and the movable contactor 29 are fixed to each other by press-fitting the side wall portions 52b as the upward-bent portions to the cutouts (press-fitted portions) 29f, the fixing positions are easy to recognize, and the fixing work is easier to perform.

It should be noted that: the fixing means for fixing the lower yoke (first yoke) 52 and the movable contactor 29 is not limited to what has been discussed above; but various fixing means are usable.

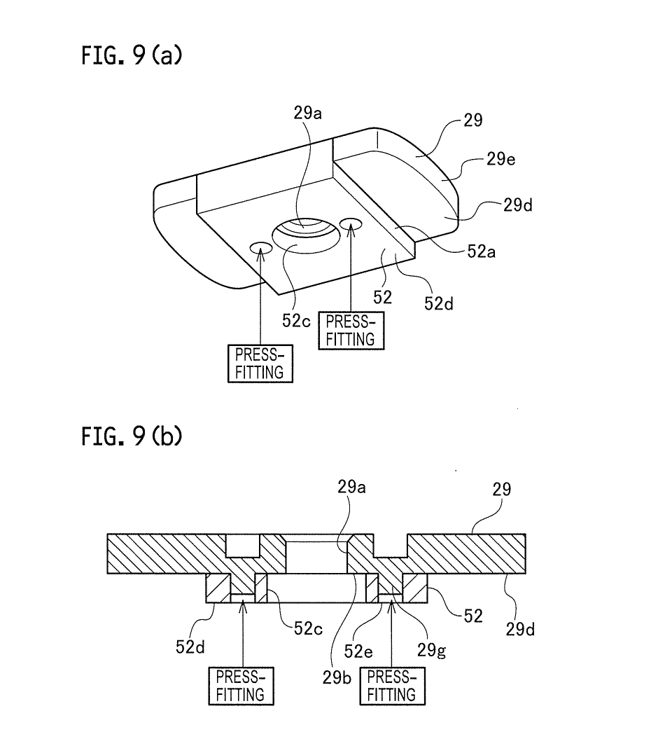

For example, the fixing can be achieved using methods shown in FIGS. 9 to 19. Even such configurations can bring about the same operation/working-effect as the foregoing embodiment.

In FIG. 9, the lower yoke (first yoke) 52 and the movable contactor 29 are fixed to each other using press-fitting means as the fixing means.

To put it concretely, the lower yoke (first yoke) 52 and the movable contactor 29 are press-fitting fixed (attached firmly) to each other by press-fitting projections (press-fitting projections) 29g formed on the lower surface 29d of the movable contactor 29 to insertion holes (press-fitted portions) 52e formed in the bottom wall portion 52a of the lower yoke (first yoke) 52. This configuration also makes it easy to recognize the fixing positions, and accordingly, makes it possible to perform the fixing work more easily.

It should be noted that the projections (press-fitting portions) 29g on the movable contactor 29 shown in FIG. 9 are formed by dowel formation processing. In addition, although FIG. 9 shows an example of the movable contactor 29 on which the two projections (press-fitting portions) 29g are formed, the number of projections (press-fitting portions) 29g may be one, three, or more.

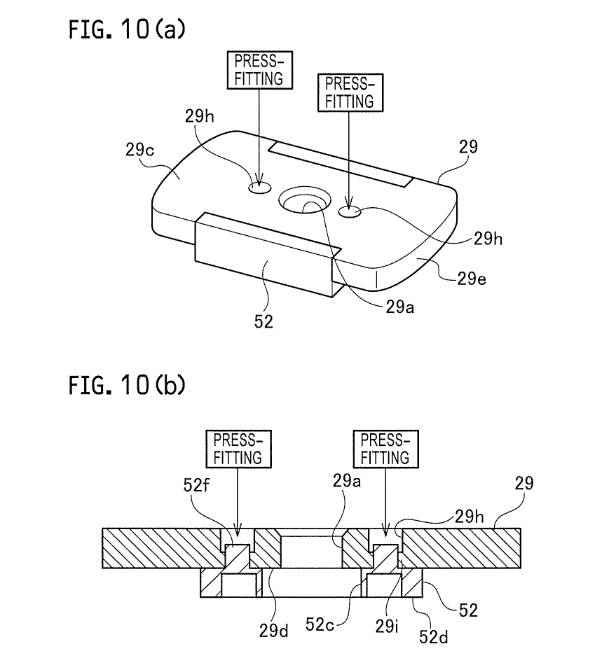

In FIG. 10, the lower yoke (first yoke) 52 and the movable contactor 29 are fixed to each other using press-fitting means as the fixing means.

To put it concretely, the lower yoke (first yoke) 52 and the movable contactor 29 are press-fitting fixed (attached firmly) to each other by press-fitting projections (press-fitting projections) 52f formed on the bottom wall portion 52a of the lower yoke (first yoke) 52 to insertion holes (press-fitted portions) 29h formed in the movable contactor 29. This configuration also makes it easy to recognize the fixing positions, and accordingly, makes it possible to perform the fixing work more easily.

The projections (press-fitting projections) 52f on the lower yoke (first yoke) 52 shown in FIG. 10 are formed by dowel formation processing. In addition, the insertion holes (press-fitted portions) 29h respectively include steps 29i formed thereon. Incidentally, although FIG. 10 shows an example of the lower yoke (first yoke) 52 on which two projections (press-fitting projections) 52f are formed, the number of projections (press-fitting projections) 52f may be one, three, or more.

Furthermore, FIGS. 9 and 10 show examples where the press-fitting portions (press-fitting projections) are formed on either the lower yoke (first yoke) 52 or the movable contactor 29. Instead, however, the press-fitting portions (press-fitting projections) may be formed on both the lower yoke (first yoke) 52 and the movable contactor 29.

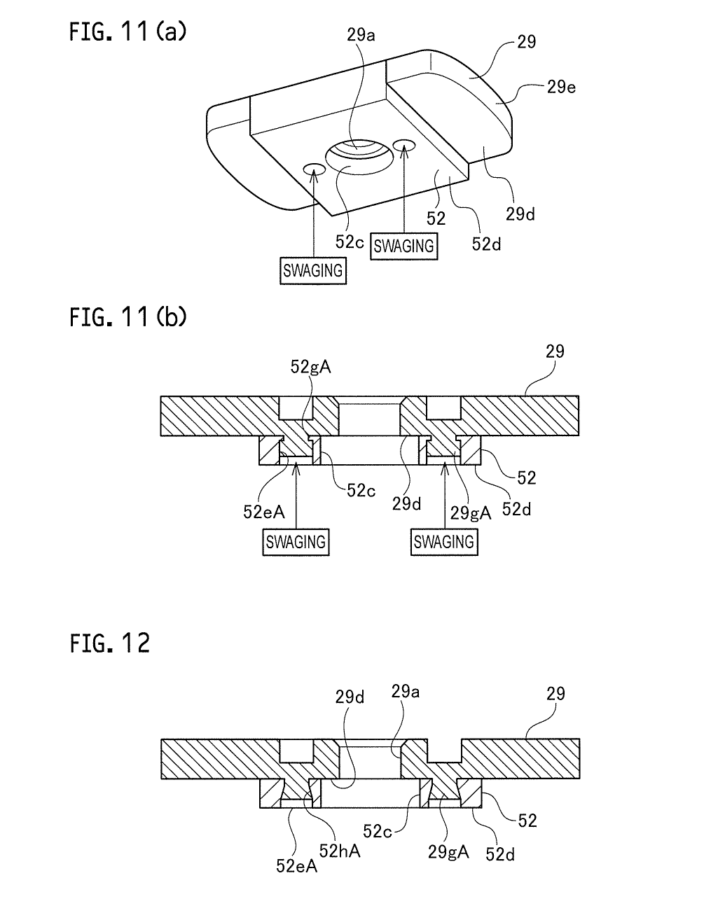

In FIG. 11, the lower yoke (first yoke) 52 and the movable contactor 29 are fixed to each other using swaging means as the fixing means.

To put it concretely, the lower yoke (first yoke) 52 and the movable contactor 29 are swaging-fixed (attached firmly) to each other by swaging projections (swaging projections) 29gA formed on the lower surface 29d of the movable contactor 29 with the projections (swaging projections) 29gA inserted (in the embodiment, press-fitted) in insertion holes (swaged portions) 52eA formed in the bottom wall portion 52a of the lower yoke (first yoke) 52. This configuration makes it possible to perform the fixing by swaging with the lower yoke (first yoke) 52 and the movable contactor 29 aligned to each other using the projections (swaging projections) 29gA, and thereby to facilitate the fixing work.

Furthermore, the projections (swaging projections) 29gA on the movable contactor 29 shown in FIG. 11 are formed by dowel formation processing as well. In addition, as shown in FIG. 11, the insertion holes (swaged portions) 52eA respectively include steps 52gA formed thereon such that after being swaged, the resultantly deformed projections (swaging projections) 29gA are brought into engagement with the steps 52gA. Thereby, their retaining strength after the swaging can be increased, and the separation between the lower yoke (first yoke) 52 and the movable contactor 29 can be more securely inhibited.

It should be noted that although FIG. 11 shows an example of the movable contactor 29 on which two projections (press-fitting projections) 29gA are formed, the number of projections (swaging projections) 29gA may be one, three, or more.

In FIG. 12, the lower yoke (first yoke) 52 and the movable contactor 29 are fixed to each other using swaging means as the fixing means.

To put it concretely, the lower yoke (first yoke) 52 and the movable contactor 29 are swaging-fixed (attached firmly) to each other by swaging the projections (swaging projections) 29gA formed on the lower surface 29d of the movable contactor 29 with the projections (swaging projections) 29gA inserted (in the embodiment, press-fitted) in the insertion holes (swaged portions) 52eA formed in the bottom wall portion 52a of the lower yoke (first yoke) 52. To this end, tapered portions 52hA whose diameters become gradually larger toward their lower sides are formed in the insertion holes (swaged portions) 52eA, respectively, such that, after being swaged, the outer peripheral surfaces of the resultantly deformed projections (swaging projections) 29gA are brought into engagement with the tapered portions 52hA. Thereby, their retaining strength after the swaging can be increased, and the separation between the lower yoke (first yoke) 52 and the movable contactor 29 can be more securely inhibited.

It should be noted that the projections (swaging projections) 29gA on the movable contactor 29 shown in FIG. 12 are formed by dowel formation processing as well. In addition, although FIG. 12 shows an example of the movable contactor 29 on which two projections (swaging projections) 29gA are formed, the number of projections (swaging projections) 29gA may be one, three, or more.

Furthermore, although FIGS. 11 and 12 show examples where either the steps 52gA or the tapered portions 52hA are formed in the insertion holes (swaged portions) 52eA, both the steps 52gA and the tapered portions 52hA may be formed in the insertion holes (swaged portions) 52eA. Otherwise, neither the steps 52gA nor the tapered portions 52hA may be formed in the insertion holes (swaged portions) 52eA. In addition, the swaging may be performed with the projections (swaging projections) 29gA only inserted in the insertion holes (swaged portions) 52eA instead of press-fitting the projections (swaging projections) 29gA in the insertion holes (swaged portions) 52eA.

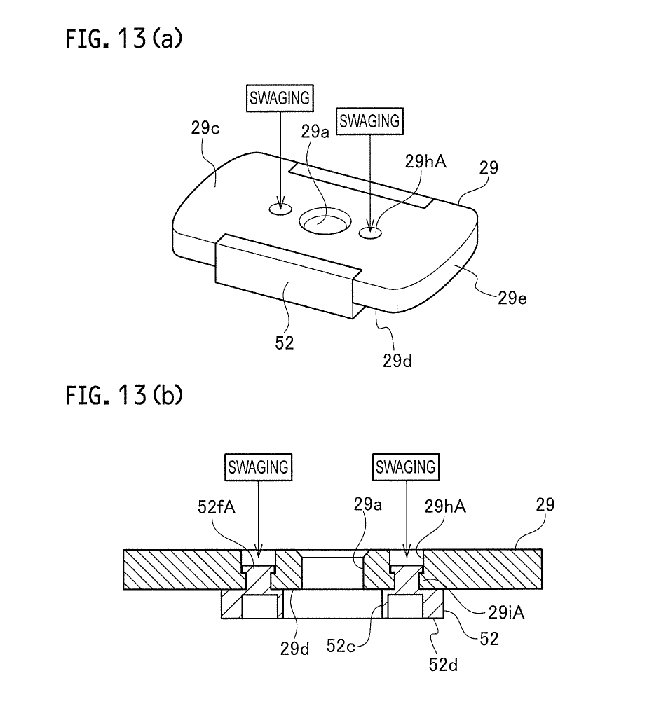

In FIG. 13, the lower yoke (first yoke) 52 and the movable contactor 29 are fixed to each other using swaging means as the fixing means.

To put it concretely, the lower yoke (first yoke) 52 and the movable contactor 29 are swaging-fixed (attached firmly) to each other by swaging projections (swaging projections) 52fA formed on the bottom wall portion 52a of the lower yoke (first yoke) 52 with the projections (swaging projections) 52fA inserted (in the embodiment, press-fitted) in insertion holes (swaged portions) 29hA formed in the movable contactor 29. This configuration makes it possible to perform the fixing by swaging with the lower yoke (first yoke) 52 and the movable contactor 29 aligned to each other using the projections (swaging projections) 52fA, and thereby to facilitate the fixing work.

In addition, the projections (swaging projections) 52fA on the lower yoke (first yoke) 52 shown in FIG. 13 are formed by dowel formation processing as well. Furthermore, as shown in FIG. 13, the insertion holes (swaged portions) 29hA respectively include steps 29iA formed thereon such that after being swaged, the resultantly deformed projections (swaging projections) 52fA are brought into engagement with the steps 29iA. Thereby, their retaining strength after the swaging can be increased, and the separation between the lower yoke (first yoke) 52 and the movable contactor 29 can be more securely inhibited.

It should be noted that although FIG. 13 shows an example of the lower yoke (first yoke) 52 on which two projections (swaging projections) 52fA are formed, the number of projections (swaging projections) 52fA may be one, three, or more. Moreover, instead of the steps 29iA, tapered portions may be formed in the insertion holes (swaged portions) 29hA. Otherwise, in addition to the steps 29iA, tapered portions may be formed in the insertion holes (swaged portions) 29hA. Besides, neither the steps 29iA nor the tapered portions may be formed in the insertion holes (swaged portions) 29hA. In addition, the swaging may be performed with the projections (swaging projections) 52fA only inserted in the insertion holes (swaged portions) 29hA instead of press-fitting the projections (swaging projections) 52fA in the insertion holes (swaged portions) 29hA.

Furthermore, FIGS. 11 to 13 show examples where the swaging portions (swaging projections) are formed on either the lower yoke (first yoke) 52 or the movable contactor 29. Instead, however, the swaging portions (swaging projections) may be formed on both the lower yoke (first yoke) 52 and the movable contactor 29.

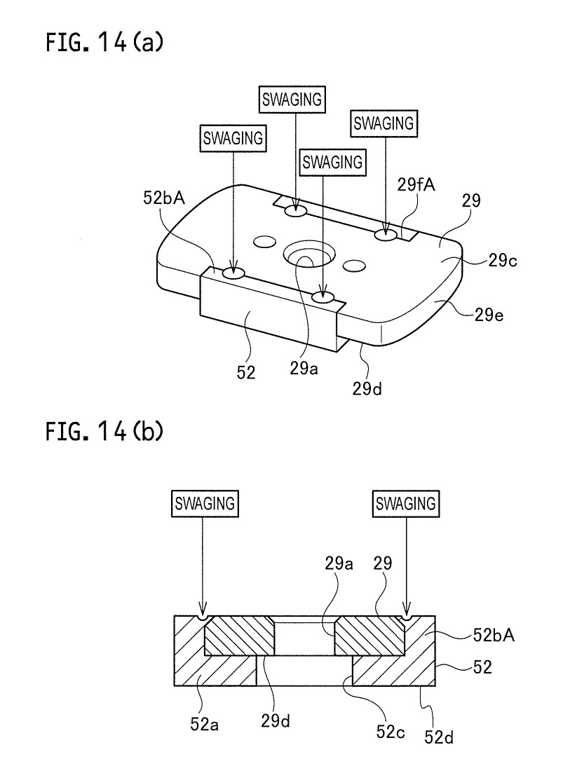

In FIG. 14, the lower yoke (first yoke) 52 and the movable contactor 29 are fixed to each other using swaging means as the fixing means.

To put it concretely, the lower yoke (first yoke) 52 and the movable contactor 29 are swaging-fixed (attached firmly) to each other by swaging side wall portions (swaging projections, or upward-bent portions) 52bA formed on the lower yoke (first yoke) 52 with the side wall portions (swaging projections, or upward-bent portions) 52bA inserted (in the embodiment, press-fitted) in cutouts (swaged portions) 29fA formed in the movable contactor 29. This configuration makes it possible to perform the fixing by swaging with the lower yoke (first yoke) 52 and the movable contactor 29 aligned to each other using the side wall portions (swaging projections, or upward-bent portions) 52bA, and thereby to facilitate the fixing work. Incidentally, although FIG. 14 shows an example of the swaging which is performed at two places on each side, the places where the swaging should be performed are not limited to thoe shown in FIG. 14.

Furthermore, in FIG. 14, too, the swaging may be performed with the side wall portions (swaging projections, or upward-bent portions) 52bA only inserted in the cutouts (swaged portions) 29fA instead of press-fitting the side wall portions (swaging projections, or upward-bent portions) 52bA in the cutouts (swaged portions) 29fA. In addition, insertion holes (swaged portions) in which to insert the side wall portions 52bA may be formed in the movable contactor 29. Moreover, swaging projections such as upward-bent portions may be formed on the movable contactor 29. Otherwise, swaging projections such as upward-bent portions may be formed on both the lower yoke (first yoke) 52 and the movable contactor 29, and swaged portions such as insertion holes may be formed in positions on the lower yoke (first yoke) 52 and the movable contactor 29 which correspond to the swaging projections such as upward-bent portions.

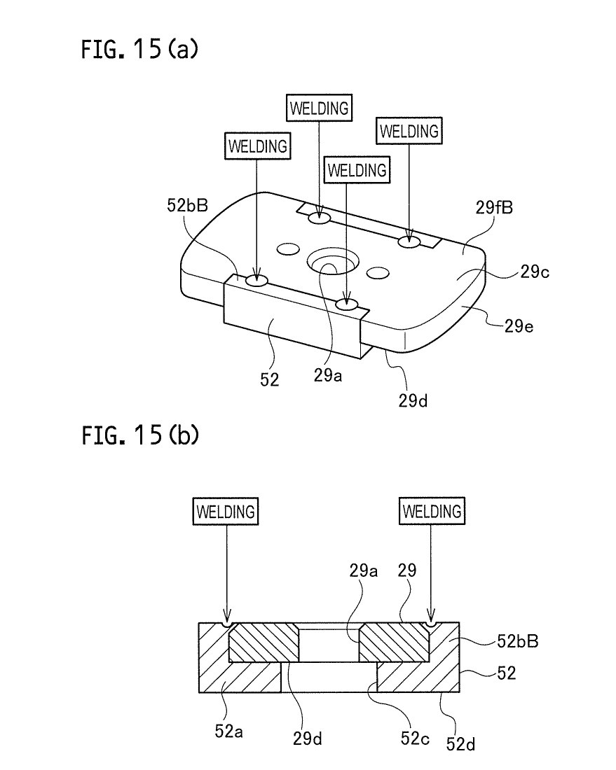

In FIG. 15, the lower yoke (first yoke) 52 and the movable contactor 29 are fixed to each other using welding means as the fixing means.

To put it concretely, the lower yoke (first yoke) 52 and the movable contactor 29 are weld-fixed (attached firmly) to each other by welding side wall portions 52bB formed on the lower yoke (first yoke) 52 to the movable contactor 29 with the side wall portions 52bB inserted (in the embodiment, press-fitted) in cutouts 29fB formed in the movable contactor 29. Since the lower yoke (first yoke) 52 is thus welded to the movable contactor 29, it is possible to achieve an increase in freedom of shape of the lower yoke (first yoke) 52 and the movable contactor 29. Incidentally, although FIG. 15 shows an example of the welding which is performed at two places on each side, the places where the welding should be performed are not limited to those shown in FIG. 15. Furthermore, the welding may be performed with the side wall portions 52bB only inserted in the cutouts 29fB instead of press-fitting the side wall portions 52bB in the cutouts 29fB.

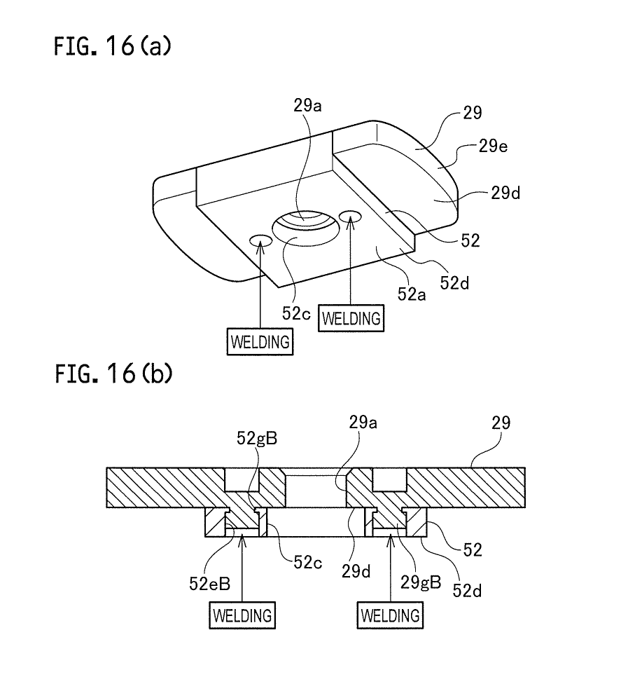

In FIG. 16, the lower yoke (first yoke) 52 and the movable contactor 29 are fixed to each other using welding means as the fixing means.

To put it concretely, the lower yoke (first yoke) 52 and the movable contactor 29 are weld-fixed (attached firmly) to each other by welding projections 29gB formed on the lower surface 29d of the movable contactor 29 to the lower yoke (first yoke) 52 with the projections 29gB inserted (in the embodiment, press-fitted) in insertion holes 52eB formed in the bottom wall portion 52a of the lower yoke (first yoke) 52. Since the lower yoke (first yoke) 52 is thus welded to the movable contactor 29, it is possible to achieve an increase in freedom of shape of the lower yoke (first yoke) 52 and the movable contactor 29.

Furthermore, the projections 29gB on the movable contactor 29 shown in FIG. 16 are formed by dowel formation processing as well. In addition, as shown in FIG. 16, the insertion holes 52eB respectively include steps 52gB formed thereon such that after being welded, the resultantly deformed projections 29gB are brought into engagement with the steps 52gB. Thereby, their retaining strength after the welding can be increased, and the separation between the lower yoke (first yoke) 52 and the movable contactor 29 can be more securely inhibited.

It should be noted that although FIG. 16 shows an example of the movable contactor 29 on which two projections 29gB are formed, the number of projections 29gB may be one, three, or more.

Moreover, instead of the steps 52gB, tapered portions may be formed in the insertion holes 52eB. Otherwise, in addition to the steps 52gB, tapered portions may be formed in the insertion holes 52eB. Moreover, neither the steps 52gB nor the tapered portions may be formed in the insertion holes 52eB. In addition, the welding may be performed with the projections 29gB only inserted in the insertion holes 52eB instead of press-fitting the projections 29gB in the insertion holes 52eB.

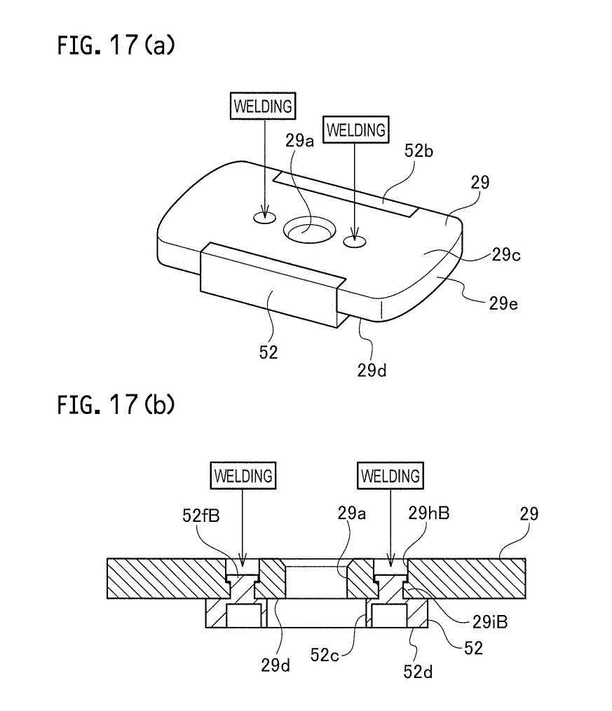

In FIG. 17, the lower yoke (first yoke) 52 and the movable contactor 29 are fixed to each other using welding means as the fixing means.

To put it concretely, the lower yoke (first yoke) 52 and the movable contactor 29 are weld-fixed (attached firmly) to each other by welding projections 52fB formed on the bottom wall portion 52a of the lower yoke (first yoke) 52 to the movable contactor 29 with the projections 52fB inserted (in the embodiment, press-fitted) in insertion holes 29hB formed in the movable contactor 29. Since the lower yoke (first yoke) 52 is thus welded to the movable contactor 29, it is possible to achieve an increase in freedom of shape of the lower yoke (first yoke) 52 and the movable contactor 29.

In addition, the projections 52fB on the lower yoke (first yoke) 52 shown in FIG. 17 are formed by dowel formation processing as well. Furthermore, as shown in FIG. 17, the insertion holes 29hB respectively include steps 29iB formed therein such that after welded, the resultantly deformed projections 52fB are brought into engagement with the steps 29iB. Thereby, their retaining strength after the welding can be increased, and the separation between the lower yoke (first yoke) 52 and the movable contactor 29 can be more securely inhibited.

It should be noted that although FIG. 17 shows an example of the lower yoke (first yoke) 52 on which two projections 52fB are formed, the number of projections 52fB may be one, three, or more.

Moreover, instead of the steps 29iB, tapered portions may be formed in the insertion hole 29hB. Otherwise, in addition to the steps 29iB, tapered portions may be formed in the insertion holes 29hB. Besides, neither the steps 29iB nor the tapered portions may be formed in the insertion holes 29hB. In addition, the welding may be performed with the projections 52fB only inserted in the insertion holes 29hB instead of press-fitting the projections 52fB in the insertion holes 29hB.

Furthermore, FIGS. 16 and 17 show examples where the projections are formed on either the lower yoke (first yoke) or the movable contactor 29. Instead, however, the projections may be formed on both the lower yoke (first yoke) 52 and the movable contactor 29.

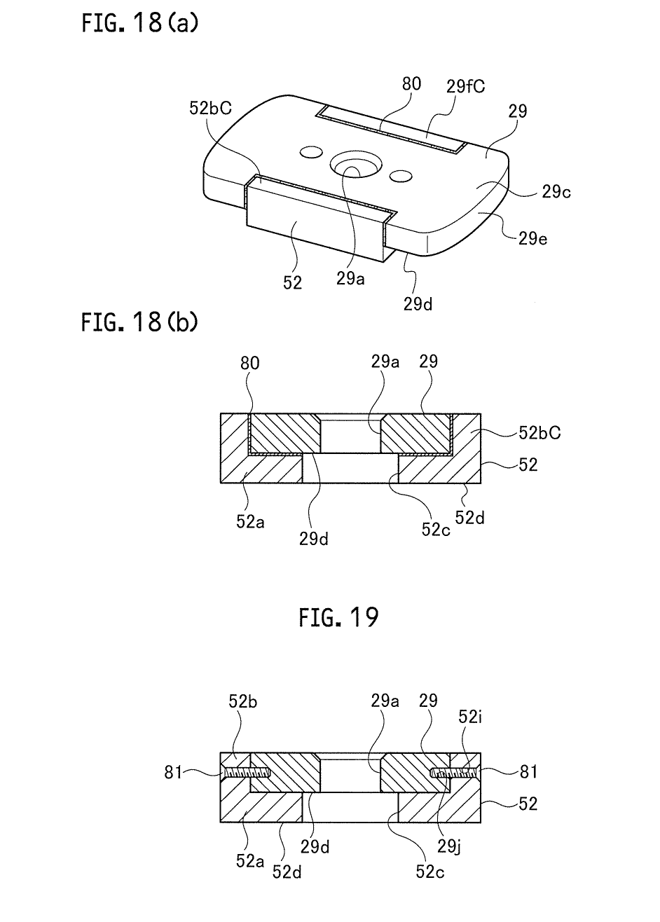

In FIG. 18, the lower yoke (first yoke) 52 and the movable contactor 29 are fixed to each other using welding means as the fixing means.

To put it concretely, the lower yoke (first yoke) 52 and the movable contactor 29 are adhesively fixed (attached firmly) to each other by bonding side wall portions 52bC of the lower yoke (first yoke) 52 to cutout portions 29fC in which to insert the side wall portions 52bC with adhesive 80 applied between the side wall portions 52bC and the cut portions 29fC. Since the lower yoke (first yoke) 52 is thus adhesively fixed to the movable contactor 29, it is possible to achieve an increase in freedom of shape of the lower yoke (first yoke) 52 and the movable contactor 29. Incidentally, although FIG. 18 shows an example where the adhesive 80 is applied to all of the mutually-facing surfaces of the side wall portions 52bC and the cutout portions 29fC, the adhesive 80 may be instead applied to part of their mutually-facing surfaces. Otherwise, the adhesive fixing may be performed by: forming projections on at least one of the lower yoke (first yoke) 52 and the movable contactor 29 by dowel formation processing or the like; and after application of the adhesive 80 to the projections, inserting the resultant projections into insertion holes, insertion recesses or the like which are formed in the other of the lower yoke (first yoke) 52 and the movable contactor 29.

In FIG. 19, the lower yoke (first yoke) 52 and the movable contactor 29 are fixed to each other using joint means as the fixing means.

To put it concretely, the side wall portions 52b of the lower yoke (first yoke) 52 include insertion portions 52i formed to extend in the horizontal direction, while side surfaces of the portions of the movable contactor 29 in which the respective cuts 29f are formed include insertion portions 29j formed to extend in the horizontal direction, and to communicate with the insertion portions 52i when the side wall portions 52b are inserted (press-fitted) in the cutouts 29f. Thereby, the lower yoke (first yoke) 52 and the movable contactor 29 are fixed (joint-fixed) to each other by inserting screws 81 as joint members in the insertion portions 52i and the insertion portions 29j with the insertion portions 52i and the insertion portions 29j communicating with each other. Since the lower yoke (first yoke) 52 and the movable contactor 29 are thus joint-fixed to each other, it is possible to achieve an increase in freedom of shape of the lower yoke (first yoke) 52 and the movable contactor 29.

It should be noted that the joint members are not limited to the screws 81. For example, bar-shaped members each with no threaded groove may be used such that ends of the bar-shaped members are press-fitted in the insertion portions 52i while the other ends thereof are press-fitted in the insertion portions 29j.

Furthermore, although the foregoing embodiment and FIGS. 9 to 19 show the examples where the side wall portions are inserted (press-fitted) in the respective cutouts, the movable contactor 29 may be provided with no cutouts so that the side surfaces of the movable contactor 29 can be held between and by the two side wall portions.

Moreover, although FIGS. 14, 15 and 18 show the examples where the projections are formed on either the lower yoke (first yoke) 52 or the movable contactor 29, no projections may be formed on either the lower yoke (first yoke) 52 or the movable contactor 29.

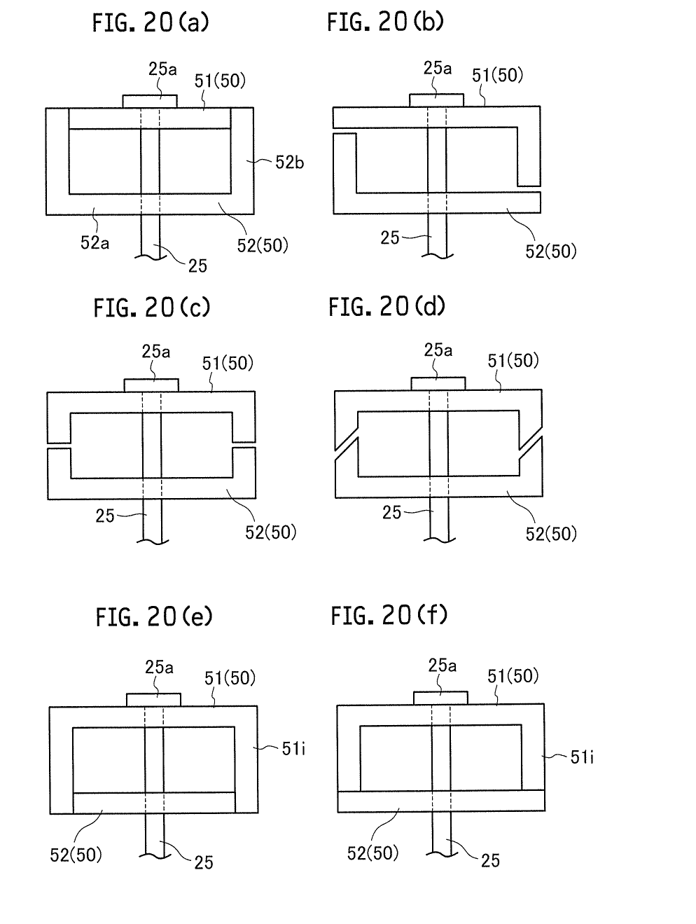

Besides, the foregoing embodiment shows the example where: the upper yoke 51 is shaped almost like a rectangular plate; and the lower yoke 52 is formed from the bottom wall portion 52a, and the side wall portions 52b formed rising from the two ends of the bottom wall portion 52a, such that the bottom wall portion 52a and the side wall portions 52b make the lower yoke 52 shaped almost like the letter U. Instead, however, the upper yoke 51 and the lower yoke 52 may take on shapes shown in FIG. 20.

To put it concretely, as shown in FIG. 20(a), the upper yoke 51 shaped almost like a rectangular plate and the lower yoke 52 shaped almost like the letter U may surround the movable contactor 29 by disposing the upper yoke 51 between the side wall portions 52b, 52b of the lower yoke 52.

Otherwise, as shown in FIG. 20 (b), the upper yoke 51 shaped like the letter L and the lower yoke 52 shaped like the letter L may surround the movable contactor 29.

Instead, as shown in FIG. 20(c), the upper yoke 51 shaped like the letter U and the lower yoke 52 shaped like the letter U may surround the movable contactor 29. In this case, as shown in FIG. 20(d), their mutually-facing surfaces may be formed obliquely.

Otherwise, as shown in FIG. 20(e), the upper yoke 51 shaped like the letter U and the lower yoke 52 shaped almost like a rectangular plate may surround the movable contactor 29. In this case, instead of disposing the lower yoke 52 shaped almost like a rectangular plate between side wall portions 51i of the upper yoke 51 shaped like the letter U, the lower yoke 52 shaped almost like a rectangular plate may be butted to the side wall portions 51i of the upper yoke 51 shaped like the letter U, as shown in FIG. 20(f).

Such shapes can bring about the same operation/working effect as the foregoing embodiment.

It should be noted that, in this case, the lower yoke (first yoke) 52 and the movable contactor 29 can be fixed to each other using the forgoing methods.

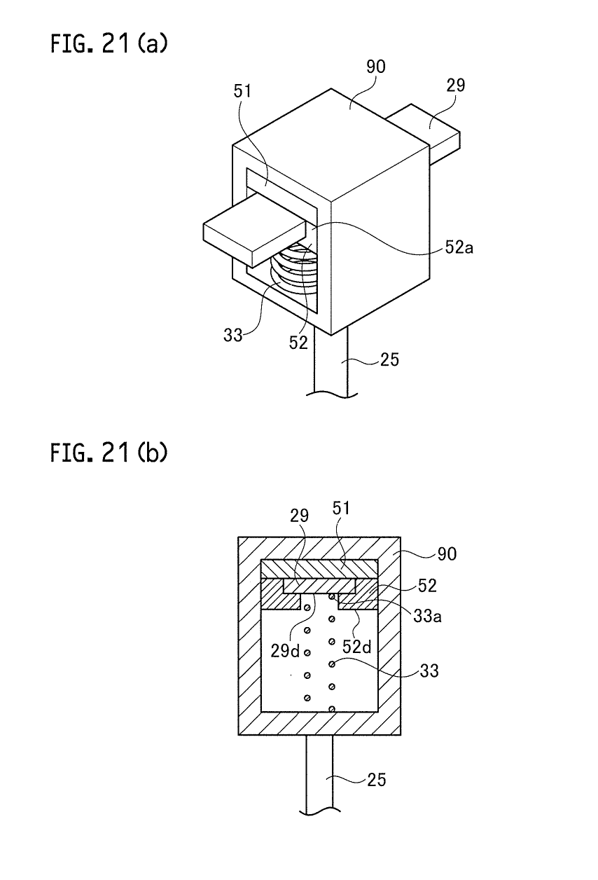

Meanwhile, as shown in FIG. 21, a structure may be used in which the movable contactor 29 is retained by a holder 90.

FIG. 21 shows an example of the holder 90 which, in a side view, is shaped almost like a rectangle, and to which the shaft 25 is fixed. FIGS. 21(a) and 21(b) show the example of the holder 90 in which the movable contactor 29 as surrounded by the upper yoke 51 and the lower yoke 52, and the contact pressure spring 33 as compressed are inserted.

Such shapes can bring about the same operation/working effect as the foregoing embodiment.

In addition, because of the structure in which the movable contactor 29 as surrounded by the upper yoke 51 and the lower yoke 52 is retained by the holder 90, it is possible to more securely inhibit the positional displacement of the lower yoke (first yoke) 52 relative to the movable contactor 29, and to more securely restrict the movable contactor 29 from going away from the fixed contacts 35a.

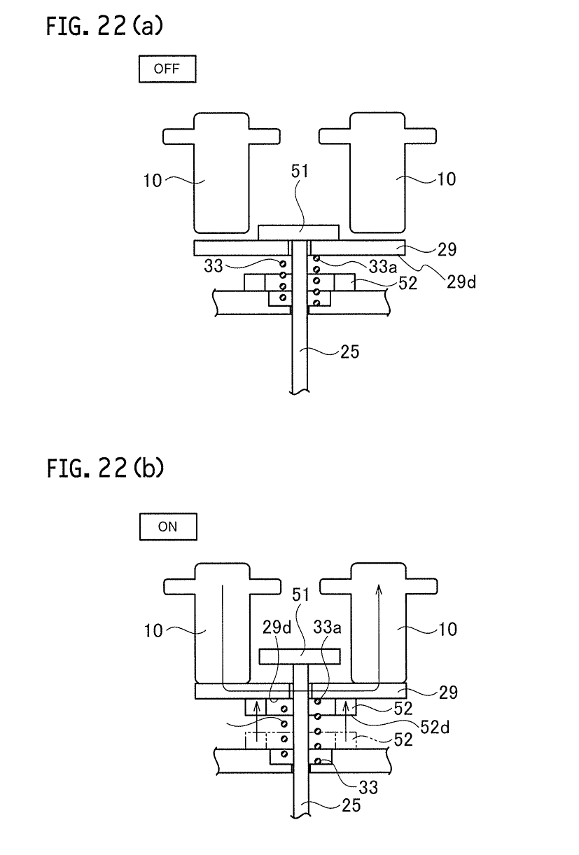

Meanwhile, as shown in FIG. 22, the lower yoke 52 may be disposed at least on the lower side of the movable contactor 29 (on the opposite side in the driving shaft direction) only while the movable contacts 29b are in contact with the fixed contacts 35a, that is to say, only while the power supply is on.

In other words, a configuration may be used in which: the lower yoke 52 are not fixed to the movable contactor 29; while the power supply is off, the lower yoke 52 is disposed under and away from the movable contactor 29; and while the power supply is on, produced magnetic force may attract the lower yoke 52 to the movable contactor 29. In this case, if the lower yoke 52 has an insertion hole 53c and is shaped like a ring so that the shaft 25 and the contact pressure spring 33 can be inserted through the insertion hole 53c, the shaft 25 and the contact pressure spring 33 function as guides so that the lower yoke 52 can be more smoothly moved relative to the movable contactor 29 in the vertical direction (the driving shaft direction).

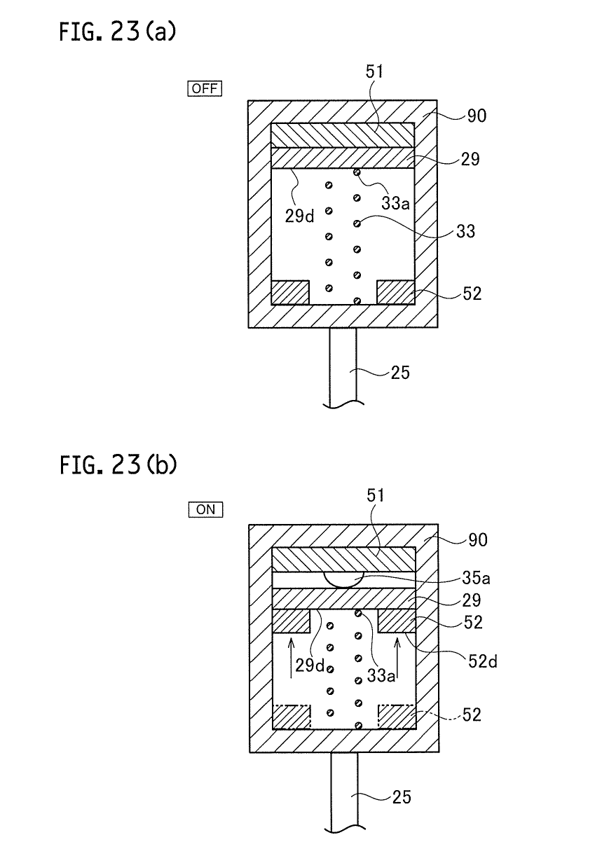

Otherwise, as shown in FIG. 23, a structure in which the movable contactor 29 is retained by the holder 90 may be used such that only while the power supply is on, the lower yoke 52 is disposed at least on the lower side of the movable contactor 29 (on the opposite side in the driving shaft direction).

This makes it possible to make the holder 90 function as a guide, and to move the lower yoke 52 relative to the movable contactor 29 in the vertical direction (the driving shaft direction) more securely and smoothly.

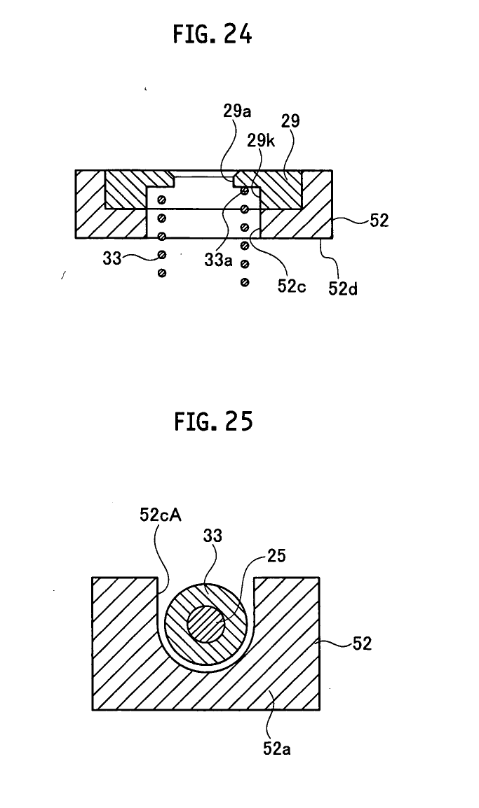

Meanwhile, as shown in FIG. 24, a lower portion of the movable contactor 29 may include an insertion hole 29k formed therein to communicate with the insertion hole 29a and to be larger in diameter than the insertion hole 29a such that the biasing end is located higher than the lower surface of the lower yoke 52. This makes it possible to make the height of the contact device 1 much smaller.

Instead, as shown in FIG. 25, the lower yoke 52 may include a cutout portion 52cA formed therein to be opened in a side portion, so that the biasing end can be located higher than the lower surface of the lower yoke 52. In other words, the lower yoke 52 may include the cutout portion (hole portion) 52cA formed to penetrate the lower yoke 52 in the driving shaft direction, and to be opened in the side portion, such that the upper end (biasing end) 33a of the contact pressure spring (biasing portion) 33 is housed inside the cutout portion (hole portion) 52cA.

This configuration can bring about the same operation/working effect as the foregoing embodiment.

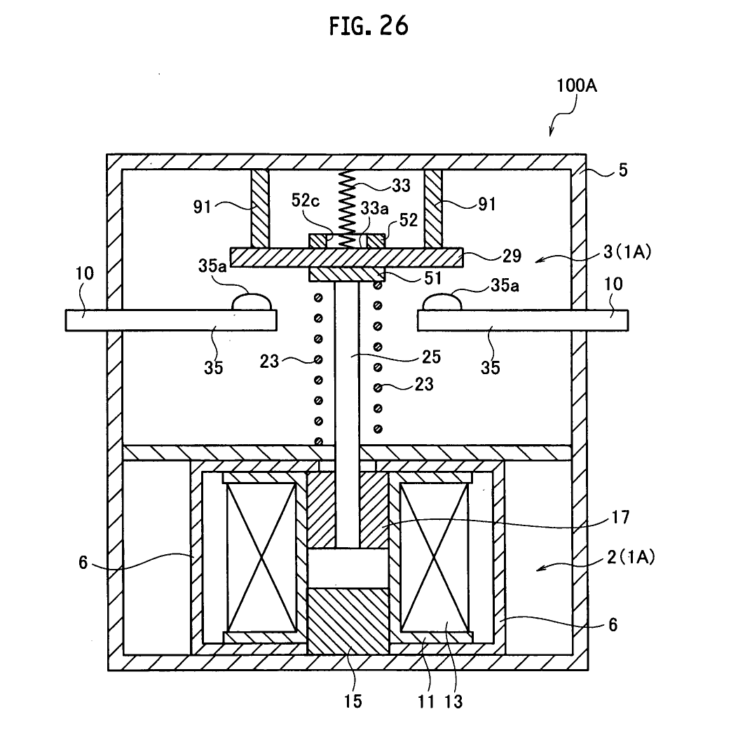

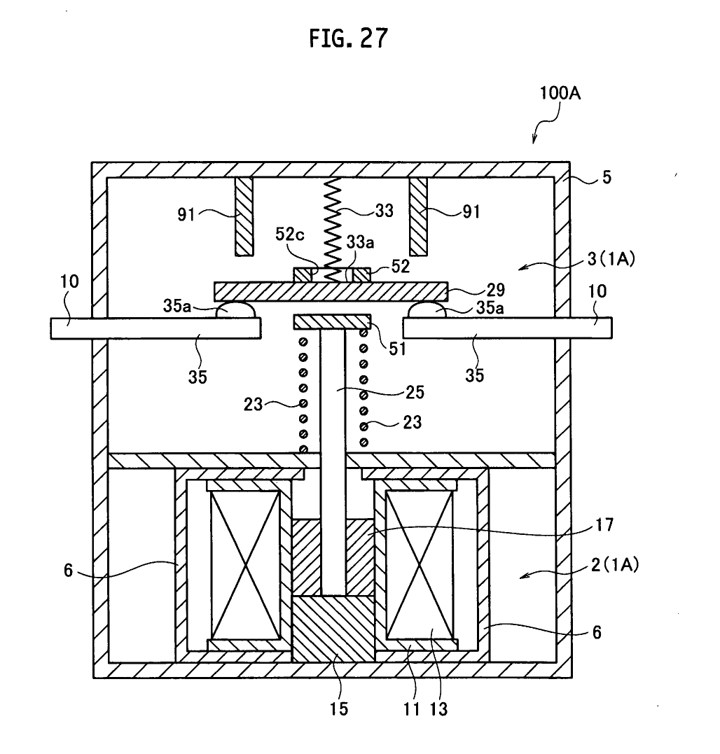

Furthermore, the foregoing embodiment shows an example where the fixed terminals 35, 35 are provided on the opposite side of the driving block 2 (inclusive of the coil and the like) from the movable contactor 29. Instead, however, a structure may be used in which, as shown in FIGS. 26 and 27, the fixed terminals 35, 35 are provided on the same side, relative to the movable contactor 29, as is the driving block 2.

FIGS. 26 and 27 show an example of an electromagnetic relay 100A mounting a contact device 1A which is formed by integrally combining: the driving block 2 to be located in the lower portion of the contact device 1A and the contact block 3 to be located in the upper portion of the contact device 1A.

The contact device 1A is housed inside the case 5 shaped like a hollow box. The pair of main terminals 10 which respectively have the fixed terminals 35 provided with the fixed contacts 35a are attached to the case 5.

In addition, the driving block 2 includes: the coil bobbin 11 shaped like a hollow cylinder with the coil 13 wound around the coil bobbin 11; and the yoke 6 made from magnetic material and surrounding the coil bobbin 11.

The driving block 2 further includes: the fixed iron core 15 fixed to the cylindrical inner portion of the coil bobbin 11 and magnetized by the coil 13 when the coil 13 is electrified; and the movable iron core 17 facing the fixed iron core 15 in the vertical direction (the axial direction) and disposed inside the cylinder of the coil bobbin 11. The range of movement of the movable iron core 17 is set between the initial position (see FIG. 26) away upward from the fixed iron core 15 and the contact position (see FIG. 27) where the movable iron core 17 is in contact with the fixed iron core 15. Furthermore, the return spring 23 formed from a coil spring biases the movable iron core 17 upward (in a direction in which the movable iron core 17 is returned to the initial position). In other words, the return spring 23 biases the movable iron core 17 in the direction in which the movable iron core 17 goes farther from the fixed iron core 15 (upward in FIG. 26).

Meanwhile, the contact block 3 includes: the pair of fixed terminals 35; and the movable contactor 29 disposed to span the pair of fixed contacts 35a. In addition, parts of the lower surface of the movable contactor 29 which face the fixed contacts 35a are respectively provided with the movable contacts.

The contact block 3 further includes a yoke to be disposed at least on the upper side of the movable contactor 29 (on the opposite side in the driving shaft direction) while the movable contacts 29b are in contact with the fixed contacts 35a (in the embodiment, while the power supply is on).

To put it concretely, the yoke is formed from: the upper yoke (first yoke) 52 disposed on the upper side of the movable contactor 29; and the lower yoke (second yoke) 51 disposed on the lower side of the movable contactor 29.

Furthermore, the shaft 25 is provided integrally with the lower yoke (second yoke) 51.

Moreover, the contact pressure spring (biasing portion) 33 formed from a coil spring biases the movable contactor 29 downward (toward the one side in the driving shaft direction).

In this respect, in the contact device 1A shown in FIGS. 26 and 27, upward biasing force applied to the movable contactor 29 by the return spring 23 is greater than downward biasing force applied to the movable contactor 29 by the contact pressure spring 33. For this reason, while the movable iron core 17 is in the initial position, the upward movement of the movable contactor 29 is restricted by a stopper 91 provided to the case 5.

Meanwhile, while the movable iron core 17 is in the contact position, the lower yoke (second yoke) 51 is brought away from the movable contactor 29 so that the return spring 23 does not bias the movable contactor 29 upward. This enables the downward biasing force of the contact pressure spring 38 to work more efficiently on the movable contactor 29.

This configuration can also bring about the same operation/working effect as the foregoing embodiment.

It should be noted that it is possible not to provide a stopper 91 if the biasing forces of the return spring 23 and the contact pressure spring 33 are adjusted appropriately. To put it concretely, the adjustment may be performed such that: while the movable iron core 17 is in the initial position, the movable contacts are put away from the fixed contacts 35a; and a balance is maintained between the biasing force applied to the movable contactor 29 by the return spring 23 and the biasing force applied to the movable contactor 29 by the contact pressure spring 33 with the distance between the fixed contacts 35a and the movable contacts being equal to or less than the distance of the movement of the movable iron core 17. This makes it possible to inhibit the upward and downward movement of the movable contactor 29 even if no stopper 91 is provided.

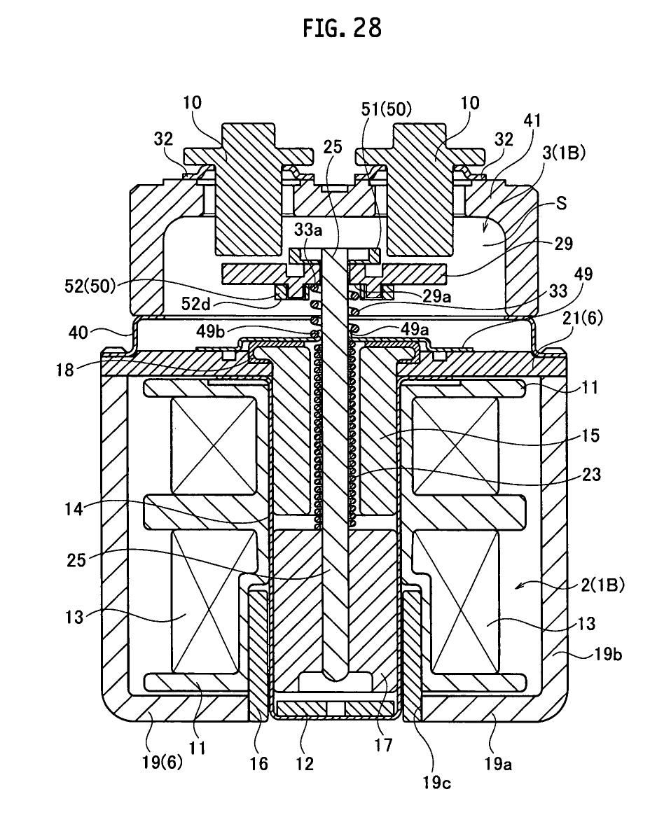

In addition, the foregoing embodiment shows an example of the contact device 1 in which the upper surface 15e of the projection 15d serves as the spring receiving portion for the contact pressure spring 33. Instead, however, a contact device 1B may be formed in which, as shown in FIG. 28, a spring receiving portion 49b for the contact pressure spring 33 is formed in the peripheral edge portion of the insertion hole 49a of the holding plate 49.

It should be noted that, in the contact device 1B, as shown in FIGS. 28 and 39, the coil 13 is wound around each of multiple (two) coil bobbins 11. Instead, however, the coil 13 may be wound around the single coil bobbin 11, as shown in FIGS. 1 to 4.

Furthermore, FIG. 28 shows an example where the movable contactor 29 and the lower yoke 52 are fixed to each other using the method shown in FIG. 9. Instead, however, the movable contactor 29 and the lower yoke 52 may be fixed to each other using other methods. Otherwise, the movable contactor 29 and the lower yoke 52 do not have to be fixed to each other.

This configuration can also bring about the same operation/working effect as the foregoing embodiment.

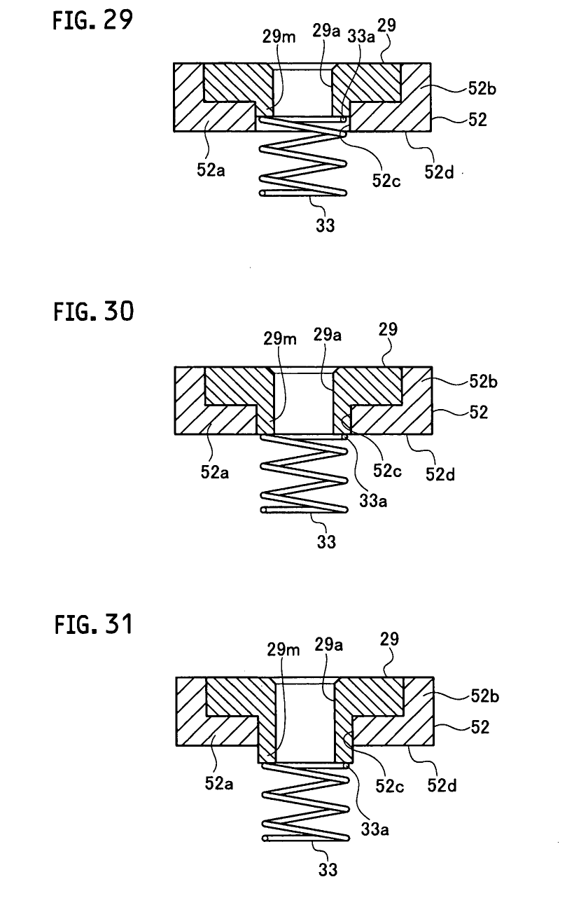

Besides, the movable contactor 29 may be pressed by the contact pressure spring (biasing portion) 33 in manners shown in FIGS. 29 to 38.

In FIG. 29, the movable contactor 29 includes a projection 29m formed to be inserted in the insertion hole 52c of the lower yoke 52. The lower surface of the projection 29m is formed to be located higher than the lower surface (the surface of the yoke 50 on the opposite side in the driving shaft direction) 52d of the lower yoke (first yoke) 52 (i.e., located on the one side in the driving shaft direction, or closer to the movable contactor 29).

Furthermore, the contact pressure spring (biasing portion) 33 includes the upper end (biasing end) 33a configured to make the upward biasing force act on the movable contactor 29 by directly pressing the movable contactor 29 which is a member other than the yoke 50.

Moreover, in FIG. 29, the upper end (biasing end) 33a of the contact pressure spring (biasing portion) 33 is configured to press the lower surface of the projection 29m.

In other words, the upper end (biasing end) 33a of the contact pressure spring (biasing portion) 33 is located higher than the lower surface (the surface of the yoke 50 on the opposite side in the driving shaft direction) 52d of the lower yoke (first yoke) 52 (i.e., located on the one side in the driving shaft direction, or closer to the movable contactor 29).

This configuration can also bring about almost the same operation/working effect as the foregoing embodiment.

Furthermore, the configuration shown in FIG. 29 increases the cross-sectional area of the movable contactor 29 by an amount corresponding to the provision of the projection 29m. For this reason, the configuration shown in FIG. 29 makes it possible to increase the area of the electrification, and to enhance the electrification performance more.

In other words, the configuration shown in FIG. 29 makes it possible to enhance the electrification performance more by reducing the size of the contact device in its height direction (the vertical direction, or the driving shaft direction).

In FIG. 30, the movable contactor 29 includes the projection 29m formed to be inserted in the insertion hole 52c of the lower yoke 52. The lower surface of the projection 29m is formed flush with the lower surface (the surface of the yoke 50 on the opposite side in the driving shaft direction) 52d of the lower yoke (first yoke) 52.

Furthermore, the contact pressure spring (biasing portion) 33 includes the upper end (biasing end) 33a configured to make the upward biasing force act on the movable contactor 29 by directly pressing the movable contactor 29 which is a member other than the yoke 50. The upper end (biasing end) 33a of the contact pressure spring (biasing portion) 33 is configured to press the lower surface of the projection 29m.

In other words, the upper end (biasing end) 33a of the contact pressure spring (biasing portion) 33 is flush with the lower surface (the surface of the yoke 50 on the opposite side in the driving shaft direction) 52d of the lower yoke (first yoke) 52.

This configuration can also bring about the same operation/working effect as the foregoing embodiment.

Furthermore, the configuration shown in FIG. 30 increases the cross-sectional area of the movable contactor 29 by the amount corresponding to the provision of the projection 29m. For this reason, the configuration shown in FIG. 30 makes it possible to increase the area of the electrification, and to enhance the electrification performance more.

The configuration like this shown in FIG. 30 makes it possible to enhance the electrification performance much more while inhibiting an increase in size of the contact device in its height direction (the vertical direction, or the driving shaft direction) to an utmost extent.

In FIG. 31, the movable contactor 29 includes the projection 29m formed to be inserted in the insertion hole 52c of the lower yoke 52. The lower surface of the projection 29m is formed to be located lower than the lower surface (the surface of the yoke 50 on the opposite side in the driving shaft direction) 52d of the lower yoke (first yoke) 52 (i.e., located on the opposite side in the driving shaft direction).

Furthermore, the contact pressure spring (biasing portion) 33 includes the upper end (biasing end) 33a configured to make the upward biasing force act on the movable contactor 29 by directly pressing the movable contactor 29 which is a member other than the yoke 50. The upper end (biasing end) 33a of the contact pressure spring (biasing portion) 33 is configured to press the lower surface of the projection 29m.

In other words, the upper end (biasing end) 33a of the contact pressure spring (biasing portion) 33 is located lower than the lower surface (the surface of the yoke 50 on the opposite side in the driving shaft direction) 52d of the lower yoke (first yoke) 52 (i.e., located on the opposite side in the driving shaft direction).

This configuration can bring about the same operation/working effect as the foregoing embodiment.

Furthermore, the configuration shown in FIG. 31 increases the cross-sectional area of the movable contactor 29 by the amount corresponding to the provision of the projection 29m. For this reason, the configuration shown in FIG. 30 makes it possible to increase the area of the electrification, and to enhance the electrification performance more. In this case, a desirable electrification performance can be obtained by appropriately adjusting the amount of projection of the projection 29m from the lower surface 52d of the lower yoke 52.

It should be noted that a part of the projection 29m which projects downward from the lower surface 52d of the lower yoke 52 may be provided with a flange portion or the like such that the flange portion or the like overlaps the lower surface 52d in a view in the driving shaft direction. In this case, the upper end (biasing end) 33a may be configured to indirectly press the yoke 50 upward by making the flange portion or the like press the lower surface 52d.

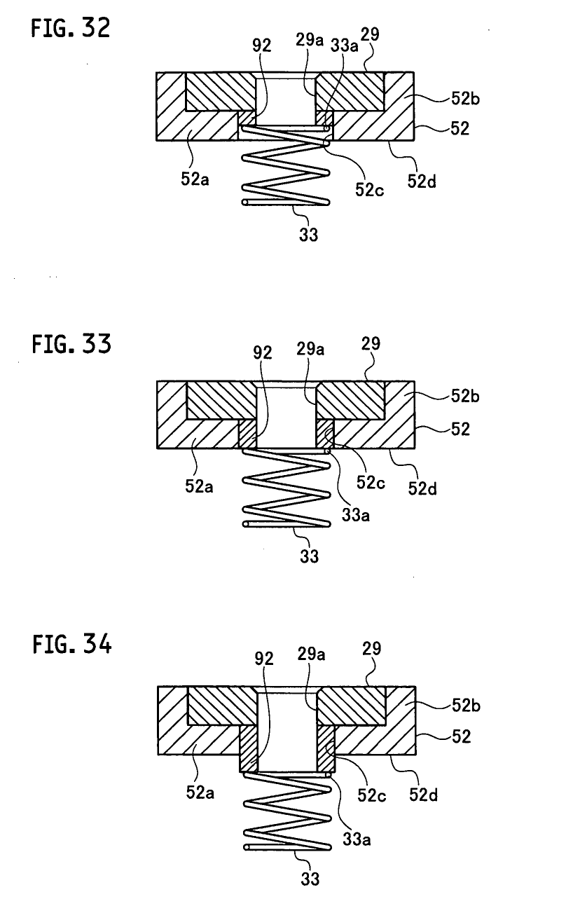

In FIG. 32, a spacer 92 formed from a member other than the yoke 50 and the movable contactor 29 is inserted in the insertion hole 52c of the lower yoke 52. The lower surface of the spacer 92 is formed to be located higher than the lower surface (the surface of the yoke 50 on the opposite side in the driving shaft direction) 52d of the lower yoke (first yoke) 52 (i.e., located on the one side in the driving shaft direction, or closer to the movable contactor 29).

Furthermore, the contact pressure spring (biasing portion) 33 includes the upper end (biasing end) 33a configured to make the upward biasing force act on the movable contactor 29 by pressing the spacer 92 which is a member other than the movable contactor 29. The upper end (biasing end) 33a of the contact pressure spring (biasing portion) 33 is configured to press the lower surface of the projection 29m.

In other words, the upper end (biasing end) 33a of the contact pressure spring (biasing portion) 33 is located higher than the lower surface (the surface of the yoke 50 on the opposite side in the driving shaft direction) 52d of the lower yoke (first yoke) 52 (i.e., located on the one side in the driving shaft direction, or closer to the movable contactor 29).

This configuration can also bring about almost the same operation/working effect as the foregoing embodiment.

In FIG. 33, the spacer 92 formed from a member other than the yoke 50 and the movable contactor 29 is inserted in the insertion hole 52c of the lower yoke 52. The lower surface of the spacer 92 is formed flush with the lower surface (the surface of the yoke 50 on the opposite side in the driving shaft direction) 52d of the lower yoke (first yoke) 52.

Furthermore, the contact pressure spring (biasing portion) 33 includes the upper end (biasing end) 33a configured to make the upward biasing force act on the movable contactor 29 by pressing the spacer 92 which is a member other than the movable contactor 29. The upper end (biasing end) 33a of the contact pressure spring (biasing portion) 33 is configured to press the lower surface of the projection 29m.

In other words, the upper end (biasing end) 33a of the contact pressure spring (biasing portion) 33 is flush with the lower surface (the surface of the yoke 50 on the opposite side in the driving shaft direction) 52d of the lower yoke (first yoke) 52.

This configuration can also bring about the same operation/working effect as the foregoing embodiment.

In FIG. 34, the spacer 92 formed from a member other than the yoke 50 and the movable contactor 29 is inserted in the insertion hole 52c of the lower yoke 52. The lower surface of the spacer 92 is formed to be located lower than the lower surface (the surface of the yoke 50 on the opposite side in the driving shaft direction) 52d of the lower yoke (first yoke) 52 (i.e., located on the opposite side in the driving shaft direction).

Furthermore, the contact pressure spring (biasing portion) 33 includes the upper end (biasing end) 33a configured to make the upward biasing force act on the movable contactor 29 by pressing the spacer 92 which is a member other than the movable contactor 29. The upper end (biasing end) 33a of the contact pressure spring (biasing portion) 33 is configured to press the lower surface of the projection 29m.

In other words, the upper end (biasing end) 33a of the contact pressure spring (biasing portion) 33 is located lower than the lower surface (the surface of the yoke 50 on the opposite side in the driving shaft direction) 52d of the lower yoke (first yoke) 52 (i.e., located on the opposite side in the driving shaft direction).

This configuration can also bring about the same operation/working effect as the foregoing embodiment.

It should be noted that a part of the spacer 92 which projects downward from the lower surface 52d of the lower yoke 52 may be provided with a flange portion or the like such that the flange portion or the like overlaps the lower surface 52d in the view in the driving shaft direction. In this case, the upper end (biasing end) 33a may be configured to indirectly press the yoke 50 upward by making the flange portion or the like press the lower surface 52d.

Furthermore, the material, shape, placement location or the like of the spacer may be designed depending on the necessity.

As described above, a member other than the yoke 50 and the movable contactor 29 may be interposed between the upper end (biasing end) 33a of the contact pressure spring (biasing portion) 33 and the movable contactor 29 such that the movable contactor 29 is biased upward with the member other than the yoke 50 and the movable contactor 29 in between.

It should be noted that in the configurations shown in FIGS. 29 to 34, the lower yoke (first yoke) 52 and the movable contactor 29 do not have to or may be fixed to each other. In the case where the lower yoke (first yoke) 52 and the movable contactor 29 are fixed to each other, the fixing may be performed using the above-described fixing means. Moreover, in the configurations shown in FIGS. 29 to 31, the lower yoke (first yoke) 52 and the movable contactor 29 may be fixed to each other by press-fitting the projection 29m to the insertion hole 52c of the lower yoke 52 instead of using the above-described fixing means. Otherwise, the projection 29m may be press-fitted in the insertion hole 52c of the lower yoke 52 in addition to using the above-described fixing means.

In FIG. 35, the upper end (biasing end) 33a of the contact pressure spring (biasing portion) 33 is in contact with the lower surface 52d which is exposed to the outside of the lower yoke 52.

To put it concretely, the diameter of the contact pressure spring 33 is enlarged such that in the view in the driving shaft direction, the lower yoke 52 is included in a circle drawn by the contact pressure spring 33.

This configuration can also bring about the same operation/working effect as the foregoing embodiment.

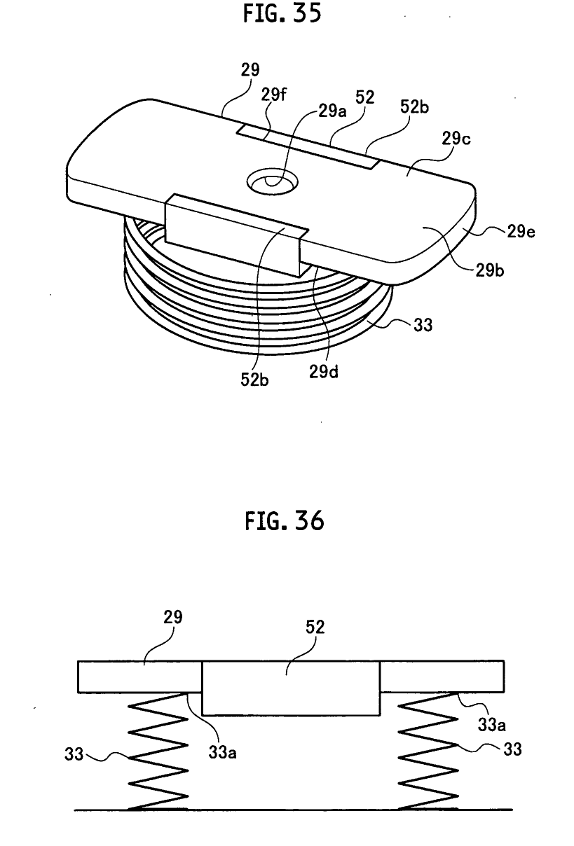

In FIG. 36, two (multiple) contact pressure springs 33 are used such that the upper ends (biasing ends) 33a of the contact pressure springs (biasing portions) 33 are in contact with parts of the lower surface 52d which are exposed to the outside of the lower yoke 52. In other words, the upper ends (biasing ends) 33a of the contact pressure springs 33 are configured to make the upward biasing force act on the movable contactor 29 by pressing a member (the movable contactor 29) which is other than the yoke 50, instead of by directly pressing the yoke 50.

This configuration can also bring about the same operation/working effect as the foregoing embodiment.

It should be noted that, in the case where multiple contact pressure springs 33 are used, it suffices that the contact pressure springs 33 include at least one biasing end located higher than the lower surface 52d of the lower yoke (first yoke) 52, and configured to make the upward biasing force act on the movable contactor 29 without being in contact with the lower yoke (first yoke) 52. For example, a pressing unit may be formed of a contact pressure spring (biasing portion) 33, and two auxiliary springs. Then, only the upper end (biasing end) 33a of the contact pressure spring (biasing portion) 33 is out of contact with the lower yoke 52 (the yoke 50); and the upper ends (biasing ends) of the other two auxiliary springs are in contact with the lower yoke 52 (the yoke 50). Otherwise, the upper ends (biasing ends) of the other two auxiliary springs are in contact with the lower yoke 52 (the yoke 50) with a member (the movable contactor 29, or another member) other than the yoke 50 interposed in between.

In FIG. 37, one plate spring 33A is used such that two ends (biasing ends, or two upper ends in FIG. 37) 33aA of the plate spring (biasing portion) 33A are in contact with parts of the lower surface 52d which are exposed to the outside of the lower yoke 52. Thereby, the two ends 33aA of the plate spring 33A serve as the biasing ends to make the upward biasing force act on the movable contactor 29 by directly pressing the movable contactor 29 which is a member other than the yoke 50.

This configuration can also bring about the same operation/working effect as the foregoing embodiment.

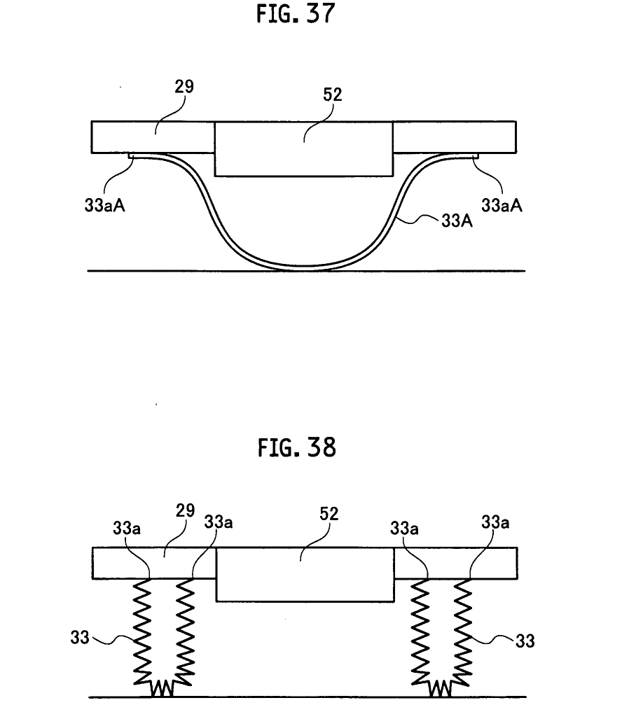

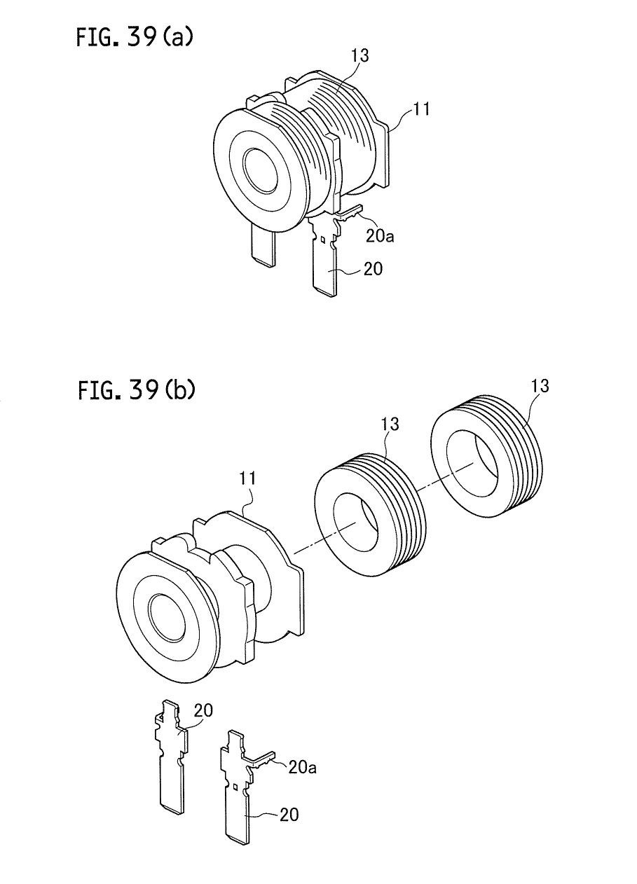

In FIG. 38, each contact pressure spring 33 is bent in the shape of the letter U such that the two ends 33a of the contact pressure spring 33 serve as biasing ends to make the upward biasing force act on the movable contactor 29 by directly pressing the movable contactor 29 which is a member other than the yoke 50. Although FIG. 38 shows an example of using two contact pressure springs 33 each bent in the shape of the letter U, the number of contact pressure springs to be used, and the number of contact pressure springs to be bent in the shape of the letter U may be set depending on the necessity.

This configuration can also bring about the same operation/working effect as the foregoing embodiment.

Although the preferable embodiment of the present invention has been described, the present invention is not limited to the embodiment, and various modifications may be made to the embodiment.

For examples, the embodiment and the modifications show the example where the movable contactor 29 is surrounded by the upper yoke 51 and the lower yoke 52. Instead, however, the movable contactor 29 may be provided with only the lower yoke 52. In addition, the shape of the lower yoke 52 is not limited to those shown above. As long as the lower yoke 52 is disposed at least on the lower side of the movable contactor 29 (on the opposite side in the driving shaft direction) (i.e., disposed in contact with the lower surface 29d) while the movable contacts 29b are in contact with the fixed contacts 35a (in the embodiment, while the power supply is on), various shapes may be used for the lower yoke 52.

In addition, the flange portion 25a of the shaft 25 may serve as the upper yoke.

Furthermore, the press-fitting projections and the swaging projections may be formed using methods which are other than the dowel formation processing.

Moreover, the configuration in which the coil 13 is wound around the multiple (two) coil bobbins 11 (the configuration shown in FIG. 39) is applicable to the contact device 1.

Besides, the structures shown in the embodiment and the modifications may be combined depending on the necessity. For example, the configurations shown in FIGS. 29 to 38 are applicable to the configuration shown in FIG. 26.

In addition, the detailed specifications (shapes, sizes, layouts and the like) of the movable contactor, the fixed terminals and the like may be changed depending on the necessity.

### INDUSTRIAL APPLICABILITY

The present invention makes it possible to obtain a contact device, and an electromagnetic relay mounting the contact device, which both achieve an increase in the freedom of layout of a biasing portion configured to bias a movable contactor.

The invention claimed is:

1. A contact device comprising:
a contact block including
a fixed terminal including a fixed contact formed thereon, and
a movable contactor including a movable contact formed to come into and out of contact with the fixed contact; and
a driving block including a driving shaft to which the movable contactor is attached, the driving block configured to drive the movable contactor so that the movable contact can come into and out of contact with the fixed contact, wherein
the contact block includes
a biasing portion configured to bias the movable contactor toward one side in a driving shaft direction, and
a yoke disposed at least on an opposite side of the movable contactor in the driving shaft direction while the movable contact is in contact with the fixed contact, and
the biasing portion includes a biasing end configured to make biasing force act on the movable contactor by pressing a member other than the yoke.

2. The contact device according to claim 1, wherein the biasing end is located on the one side in the driving shaft direction rather than on a surface of the yoke on the opposite side in the driving shaft direction.

3. The contact device according to claim 1,
wherein the biasing end is flush with a surface of the yoke on the opposite side in the driving shaft direction, or located on the opposite side in the driving shaft direction rather than on a surface of the yoke on the opposite side in the driving shaft direction.

4. The contact device according to claim 1, wherein the biasing portion directly biases the movable contactor.

5. The contact device according to claim 1, wherein the biasing portion biases the movable contactor by pressing a member other than the movable contactor.

6. The contact device according to claim 1, wherein
the yoke includes at least a hole portion formed to penetrate the yoke in the driving shaft direction, and
the biasing end is housed inside the hole portion.

7. The contact device according to claim 1, wherein
the yoke includes a first yoke including at least a part disposed on the opposite side of the movable contactor in the driving shaft direction, and
the first yoke and the movable contactor are fixed to each other using fixing means.

8. The contact device according to claim 7, wherein the fixing means includes press-fitting means configured to fix the first yoke and the movable contactor by press-fitting a press-fitting portion, which is formed on at least any one of the first yoke and the movable contactor, to a press-fitted portion which is formed in the other of the first yoke and the movable contactor.

9. The contact device according to claim 8, wherein the press-fitting portion includes a press-fitting projection formed in at least one of the first yoke and the movable contactor.

10. The contact device according to claim 9, wherein the press-fitting projection includes a projection formed by dowel formation processing.

11. The contact device according to claim 10, wherein the press-fitted portion includes at least one of an insertion hole and an insertion recess in which to insert the press-fitting projection.

12. The contact device according to claim 11, wherein the press-fitted portion includes a step.

13. The contact device according to claim 11, wherein the press-fitted portion includes a tapered portion.

14. The contact device according to claim 9, wherein the press-fitting projection includes an upward-bent portion formed on at least one of the first yoke and the movable contactor.

15. The contact device according to claim 7, wherein the fixing means includes swaging means configured to fix the first yoke and the movable contactor by swaging a swaging portion, which is formed on at least one of the first yoke and the movable contactor, to a swaged portion which is formed in the other of the first yoke and the movable contactor.

16. The contact device according to claim 15, wherein the swaging portion includes a swaging projection formed on at least one of the first yoke and the movable contactor.

17. The contact device according to claim 16, wherein the swaging projection includes a projection formed by dowel formation processing.

18. The contact device according to claim 16, wherein the swaged portion includes an insertion hole in which to insert the swaging projection.

19. The contact device according to claim 18, wherein the swaged portion includes a step.

20. The contact device according to claim 18, wherein the swaged portion includes a tapered portion.

21. The contact device according to claim 18, wherein the swaging projection is swaged while press-fitted in the insertion hole.

22. The contact device according to claim 15, wherein the swaging projection includes an upward-bent portion formed on at least one of the first yoke and the movable contactor.

23. The contact device according to claim 7, wherein the fixing means includes welding means configured to fix the first yoke and the movable contactor by welding.

24. The contact device according to claim 7, wherein the fixing means includes bonding means configured to fix the first yoke and the movable contactor with an adhesive.

25. The contact device according to claim 7, wherein the fixing means includes joint means configured to fix the first yoke and the movable contactor by inserting a joint member through insertion portions respectively formed in the first yoke and the movable contactor.

26. An electromagnetic relay mounting the contact device according to claim 1.
